(19) United States
(12) Patent Application Publication
(10) Pub. No.: US 2015/0043434 A1
(43) Pub. Date: Feb. 12, 2015

(54) SYSTEMS AND METHODS FOR SUBFRAME BUNDLING

(71) Applicant: Sharp Laboratories of America, Inc., Camas, WA (US)

(72) Inventors: Shohei Yamada, Camas, WA (US); Zhanping Yin, Vancouver, WA (US)

(73) Assignee: Sharp Laboratories of America, Inc., Camas, WA (US)

(21) Appl. No.: 13/962,887

(22) Filed: Aug. 8, 2013

(51) Int. Cl. H04W 72/04

(52) U.S. Cl. CPC H04W 72/0446
USPC 370/329

(57) ABSTRACT

A User Equipment (UE) for performing subframe bundling is described. The UE includes a processor and instructions stored in memory that is in electronic communication with the processor. The UE determines consecutive uplink (UL) subframes based on UL subframes of a UL-reference uplink/downlink (UL/DL) configuration of a serving cell. The UE also performs a subframe bundling operation based on the consecutive UL subframes.

### TECHNICAL FIELD

The present disclosure relates generally to communication systems. More specifically, the present disclosure relates to systems and methods for subframe bundling.

### BACKGROUND

Wireless communication devices have become smaller and more powerful in order to meet consumer needs and to improve portability and convenience. Consumers have become dependent upon wireless communication devices and have come to expect reliable service, expanded areas of coverage and increased functionality. A wireless communication system may provide communication for a number of wireless communication devices, each of which may be serviced by a base station. A base station may be a device that communicates with wireless communication devices.

As wireless communication devices have advanced, improvements in communication capacity, speed, flexibility and/or efficiency have been sought. However, improving communication capacity, speed, flexibility and/or efficiency may present certain problems.

For example, wireless communication devices may communicate with one or more devices using a communication structure. However, the communication structure used may only offer limited flexibility and/or efficiency. As illustrated by this discussion, systems and methods that improve communication flexibility and/or efficiency may be beneficial.

### BRIEF DESCRIPTION OF THE DRAWINGS

FIG. 1 is a block diagram illustrating one configuration of one or more evolved Node Bs (eNBs) and one or more User Equipments (UEs) in which systems and methods for configuration signaling may be implemented;

FIG. 2 is a flow diagram illustrating one implementation of a method for subframe bundling by a UE;

FIG. 3 is a flow diagram illustrating one implementation of a method for configuration signaling by an eNB;

FIG. 4 is a diagram illustrating one example of a radio frame that may be used in accordance with the systems and methods disclosed herein;

FIGS. 5A and 5B illustrate options for subframe bundling;

FIGS. 6A and 6B illustrate more options for subframe bundling;

FIGS. 7A and 7B illustrate yet more options for subframe bundling;

FIG. 8 illustrates one example of subframe bundling with dynamic subframe type conversion according to a first implementation;

FIG. 9 illustrates another example of subframe bundling with dynamic subframe type conversion according to a first implementation;

FIG. 10 illustrates yet another example of subframe bundling with dynamic subframe type conversion according to a first implementation;

FIG. 11 illustrates one example of subframe bundling with dynamic subframe type conversion according to a second implementation;

FIG. 12 illustrates another example of subframe bundling with dynamic subframe type conversion according to the second implementation;

FIG. 13 illustrates yet another example of subframe bundling with dynamic subframe type conversion according to the second implementation;

FIG. 14 illustrates various components that may be utilized in a UE;

FIG. 15 illustrates various components that may be utilized in an eNB;

FIG. 16 is a block diagram illustrating one configuration of a UE in which systems and methods for subframe bundling may be implemented; and

FIG. 17 is a block diagram illustrating one configuration of an eNB in which systems and methods for subframe bundling may be implemented.

### DETAILED DESCRIPTION

A UE for performing subframe bundling is described. The UE includes a processor and instructions stored in memory that is in electronic communication with the processor. The UE determines consecutive uplink (UL) subframes based on UL subframes of a UL-reference uplink/downlink (UL/DL) configuration of a serving cell. The UE also performs a subframe bundling operation based on the consecutive UL subframes.

The UE may also drop a physical uplink shared channel (PUSCH) transmission in a subframe in a bundle if the subframe is determined to be a non-PUSCH transmission subframe. Determining whether the subframe is a non-PUSCH transmission subframe may be based on physical (PHY) layer signaling. Determining whether the subframe is a non-PUSCH transmission subframe may be based on a predetermined time division duplexing (TDD) UL/DL configuration. Determining whether the subframe is a non-PUSCH transmission subframe may be based on a UL grant for the subframe.

The consecutive UL subframes may include a number of UL subframes corresponding to a transmission time interval (TTI) bundle size. A PUSCH transmission in the flexible subframe may not occur. The serving cell may be configured to perform a dynamic subframe type conversion.

The UE may determine the UL-reference UL/DL configuration based on a pair of a first UL/DL configuration and a second UL/DL configuration. The UE may determine the UL-reference UL/DL configuration based on radio resource control (RRC) dedicated signaling.

An evolved Node B (eNB) for performing subframe bundling is also described. The eNB includes a processor and instructions stored in memory that is in electronic communication with the processor. The eNB determines consecutive UL subframes based on UL subframes of a UL-reference UL/DL configuration of a serving cell. The eNB also performs a subframe bundling operation based on the consecutive UL subframes.

The eNB may assume that a PUSCH transmission in a subframe in a bundle is dropped if the subframe is determined to be a non-PUSCH transmission subframe. Determining whether the subframe is a non-PUSCH transmission subframe may be based on PHY layer signaling. Determining whether the subframe is a non-PUSCH transmission subframe may be based on a predetermined TDD UL/DL configuration. Determining whether the subframe is a non-PUSCH transmission subframe may be based on a UL grant for the subframe.

The consecutive UL subframes may include a number of UL subframes corresponding to a TTI bundle size. A PUSCH transmission in the flexible subframe may not occur. The serving cell may be configured to perform a dynamic subframe type conversion.

The eNB may determine the UL-reference UL/DL configuration based on a pair of a first UL/DL configuration and a second UL/DL configuration. The eNB may determine the UL-reference UL/DL configuration based on RRC dedicated signaling.

A method for performing subframe bundling by a UE is also described. The method includes determining consecutive UL subframes based on UL subframes of a UL-reference UL/DL configuration of a serving cell. The method also includes performing a subframe bundling operation based on the consecutive UL subframes.

A method for performing subframe bundling by an eNB is also described. The method includes determining consecutive UL subframes based on UL subframes of a UL-reference UL/DL configuration of a serving cell. The method also includes performing a subframe bundling operation based on the consecutive UL subframes.

The 3rd Generation Partnership Project, also referred to as “3GPP,” is a collaboration agreement that aims to define globally applicable technical specifications and technical reports for third and fourth generation wireless communication systems. The 3GPP may define specifications for next generation mobile networks, systems and devices.

3GPP Long Term Evolution (LTE) is the name given to a project to improve the Universal Mobile Telecommunications System (UMTS) mobile phone or device standard to cope with future requirements. In one aspect, UMTS has been modified to provide support and specification for the Evolved Universal Terrestrial Radio Access (E-UTRA) and Evolved Universal Terrestrial Radio Access Network (E-UTRAN).

At least some aspects of the systems and methods disclosed herein may be described in relation to the 3GPP LTE, LTE-Advanced (LTE-A) and other standards (e.g., 3GPP Releases 8, 9, 10 and/or 11). However, the scope of the present disclosure should not be limited in this regard. At least some aspects of the systems and methods disclosed herein may be utilized in other types of wireless communication systems.

A wireless communication device may be an electronic device used to communicate voice and/or data to a base station, which in turn may communicate with a network of devices (e.g., public switched telephone network (PSTN), the Internet, etc.). In describing systems and methods herein, a wireless communication device may alternatively be referred to as a mobile station, a UE, an access terminal, a subscriber station, a mobile terminal, a remote station, a user terminal, a terminal, a subscriber unit, a mobile device, etc. Examples of wireless communication devices include cellular phones, smart phones, personal digital assistants (PDAs), laptop computers, netbooks, e-readers, wireless modems, etc. In 3GPP specifications, a wireless communication device is typically referred to as a UE. However, as the scope of the present disclosure should not be limited to the 3GPP standards, the terms “UE” and “wireless communication device” may be used interchangeably herein to mean the more general term “wireless communication device.”

In 3GPP specifications, a base station is typically referred to as a Node B, an evolved Node B (eNB), a home enhanced or evolved Node B (HeNB) or some other similar terminology. As the scope of the disclosure should not be limited to 3GPP standards, the terms “base station,” “Node B,” “eNB” and “HeNB” may be used interchangeably herein to mean the more general term “base station.” Furthermore, the term “base station” may be used to denote an access point. An access point may be an electronic device that provides access to a network (e.g., Local Area Network (LAN), the Internet, etc.) for wireless communication devices. The term “communication device” may be used to denote both a wireless communication device (e.g., UE) and/or a base station (e.g., eNB).

It should be noted that as used herein, a “cell” may refer to any set of communication channels over which the protocols for communication between a UE and an eNB that may be specified by standardization or governed by regulatory bodies to be used for International Mobile Telecommunications-Advanced (IMT-Advanced) or its extensions and all of it or a subset of it may be adopted by 3GPP as licensed bands (e.g., frequency bands) to be used for communication between an eNB and a UE. “Configured cells” are those cells of which the UE is aware and is allowed by an eNB to transmit or receive information. “Configured cell(s)” may be serving cell(s). The UE may receive system information and perform the required measurements on all configured cells. “Activated cells” are those configured cells on which the UE is transmitting and/or receiving. That is, activated cells are those cells for which the UE monitors the physical downlink control channel (PDCCH) and in the case of a downlink transmission, those cells for which the UE decodes a physical downlink shared channel (PDSCH). “Deactivated cells” are those configured cells that the UE is not monitoring the transmission PDCCH. It should be noted that a “cell” may be described in terms of differing dimensions. For example, a “cell” may have temporal, spatial (e.g., geographical) and frequency characteristics.

The systems and methods disclosed herein describe subframe bundling. In particular, the systems and methods disclosed herein describe subframe bundling with dynamic subframe type conversion. It should be noted that subframe bundling may also be referred to as transmission time interval (TTI) bundling. Furthermore, dynamic subframe type conversion may also be referred to as enhanced interference mitigation with traffic adaptation (eIMTA) or dynamic TDD UL/DL reconfiguration. Therefore, a serving cell that supports dynamic subframe type conversion may be referred to as an eIMTA cell. The described systems and methods provide the benefit of efficient utilization of dynamic subframe type conversion.

Enhanced interference mitigation with traffic adaptation (eIMTA) is a major topic for LTE TDD networks to enable more flexible use of spectrum using dynamic TDD UL/DL allocation based on traffic load. Therefore, some subframes may be flexible and convertible and may be used as either special, downlink or uplink as described below. A TDD UL/DL configuration may also be referred to as a TDD UL-DL reconfiguration.

Several signaling methods have been considered in an LTE Release-11 study, including system information change, radio resource control (RRC) signaling, medium access control (MAC) signaling and physical (PHY) layer signaling. It was concluded that the faster the reconfiguration is, the higher the benefits from eIMTA. The reconfiguration time scale and signaling methods can be divided into two categories. In a first approach, a new TDD UL/DL configuration is signaled, and then a transition from the old TDD UL/DL configuration to the new TDD UL/DL configuration is performed. In this approach, the transition behavior has to be specified. During the transition period, the association timing has to be changed from the old TDD UL/DL configuration to the new TDD UL/DL configuration. In a second approach, multiple reference UL/DL configurations may be signaled, one or more reference UL/DL configurations may be determined and the reference UL/DL configurations may be followed to achieve different TDD UL/DL subframe allocations.

In the systems and methods described herein, the second approach (e.g., signaling multiple reference UL/DL configurations) is considered. In this approach a UL-reference UL/DL configuration may define a physical uplink shared channel (PUSCH) to physical hybrid automatic repeat request (HARQ) indicator channel (PHICH) (e.g., PUSCH-to-PHICH) timing, a downlink control information (DCI)/PHICH-to-PUSCH timing (e.g., PUSCH HARQ transmission timing) and the number of HARQ processes for a UL.

The DL-reference UL/DL configuration may define a PDSCH-to-acknowledgement (ACK) timing (e.g., PDSCH HARQ-ACK transmission timing), the maximum number of HARQ processes for DL side and HARQ-ACK signaling in the UL (e.g. the size of the HARQ-ACK codebook). The actual UL/DL configuration of a radio frame may be explicitly signaled via a PHY layer signaling. For example, the UE may receive the UL/DL configuration on a PDCCH or an EPDCCH. A UE may determine a subframe type based on the explicitly signaled UL/DL configuration in the PHY layer. If the UE could not receive the PHY layer signaling (e.g., the PHY layer signaling is not correctly decoded), the UE may determine the subframe type (e.g., downlink subframe, uplink subframe, or special subframe) of the subframe based on a predetermined UL/DL configuration (e.g., TDD UL/DL configuration, DL-reference UL/DL configuration, or UL-reference UL/DL configuration) and/or may determine the subframe type based on the UL grant and/or PHICH for the subframe such that the subframe for which the UL grant and/or PHICH indicates PUSCH transmission is an UL subframe or a special subframe that is used for PUSCH transmission and the subframe for which the UL grant and/or PHICH do not indicate PUSCH transmission is a predetermined subframe type of the predetermined UL/DL configuration.

In another example, the system may not use the PHY layer signaling. The UE may determine the subframe type (e.g., downlink subframe, uplink subframe, or special subframe) of the subframe based on a predetermined UL/DL configuration (e.g., TDD UL/DL configuration, DL-reference UL/DL configuration, or UL-reference UL/DL configuration) and/or may determine the subframe type based on the UL grant and/or PHICH for the subframe such that the subframe for which the UL grant and/or PHICH indicates PUSCH transmission is an UL subframe or a special subframe that is used for PUSCH transmission and the subframe for which the UL grant and/or PHICH do not indicate PUSCH transmission is a predetermined subframe type of the predetermined UL/DL configuration. If a subframe type of a subframe is determined as a DL subframe or a special subframe that is not used for PUSCH transmission, the subframe may also be determined as a non-PUSCH transmission subframe.

A serving cell with dynamic subframe type conversion is a TDD cell that supports eIMTA to adapt the traffic load on the cell. In LTE time-division duplexing (LTE TDD), the same frequency band may be used for both uplink and downlink signals. To achieve different DL and UL allocations (e.g., traffic ratios) in LTE TDD, seven TDD UL/DL configurations are given in 3GPP specifications (e.g., 3GPP TS 36.211). These allocations can allocate between 40% and 90% of subframes to DL signals.

According to current specifications (e.g., LTE Releases 8, 9, 10 and 11), a system information change procedure is used to change the TDD UL/DL configuration. This procedure has a long delay, and requires a cold system restart (e.g., all UEs in a system cannot transmit and receive for a certain period of time in order to disconnect the TDD UL/DL associations of the old TDD UL/DL configuration and set up new associations). It should be noted that a subframe association may be referred to as a “UL/DL association,” which may include UL-to-DL subframe associations and DL-to-UL subframe associations. Examples of associations include association of a DL subframe (PDCCH) to UL power control in a UL subframe, association of a DL subframe PDCCH to physical UL shared channel (PUSCH) allocation in a UL subframe, associations of acknowledgement and negative acknowledgement (ACK/NACK) feedback on UL subframe(s) for physical downlink shared channel (PDSCH) transmissions in DL subframe(s), association of acknowledgement and negative acknowledgement (ACK/NACK) feedback on a PHICH or physical downlink control channel (PDCCH) for PUSCH transmission(s) in UL subframe(s), etc.

Dynamic subframe type conversion may be applied for both DL-to-UL and UL-to-DL reconfiguration or switching. Dynamic subframe type conversion allows applying one UL/DL configuration for PDSCH hybrid automatic repeat request acknowledgement (HARQ-ACK) timing and applying another UL/DL configuration for PUSCH scheduling and PUSCH HARQ-ACK timing. UEs that support dynamic subframe type conversion may follow these timings based on the corresponding reference UL/DL configurations in an allowed UL/DL reconfiguration range (e.g., switching region). Legacy UEs may follow the existing associations without any change or knowledge of the dynamic subframe type conversion. However, the eNB may restrict the legacy UEs in some subframes to maintain backward compatible timing.

In known LTE TDD systems, the UL and DL allocation is chosen from seven defined TDD UL/DL configurations, and is synchronized system-wide. Currently, TDD UL/DL allocation reconfiguration in a cell may be very costly because all transmissions have to be stopped to adjust the TDD UL/DL associations. A change in one cell may cause or accompany a sequence of changes at neighbor cells (and their neighbor cells, etc.) to match TDD UL/DL configuration synchronization at neighbor cells (and their neighbor cells, etc.). Furthermore, current TDD UL/DL allocation reconfiguration requires a system information change, which has long delay and is not adaptive to instantaneous or short-term changes in traffic load.

In current specifications (e.g., LTE Releases 8, 9, 10 and 11), a system information change procedure may be used to change the TDD UL/DL configuration. This procedure requires multiple broadcast channel intervals and thus has a long delay and cannot adapt to an instantaneous traffic load change. Due to different TDD UL/DL associations, all transmitters may have to turn off transmissions altogether to disconnect the TDD UL/DL associations of the old TDD UL/DL configuration and to set up the new associations.

This may cause a huge loss of system capacity (e.g., offered load on uplink or downlink) and user traffic interruption. Therefore, the reconfiguration of UL and DL allocation may also be very costly. Furthermore, a change in one cell may force adjacent cells to change their TDD UL/DL configurations. Thus, a “ripple” effect may occur. With high traffic load fluctuation, frequent TDD UL/DL reconfiguration may cause serious network problems.

When the network aggregated traffic load-to-capacity ratio is low, a TDD UL/DL configuration is acceptable if the UL traffic and DL traffic load can be supported by the allocated UL subframes and DL subframes, respectively. In this case, the actual TDD UL/DL traffic ratio may be the same or different from the TDD UL/DL allocation. On the other hand, if the total traffic load-to-capacity ratio is high, a better matching TDD UL/DL ratio may be configured.

A reconfiguration may be needed in several cases. For example, a reconfiguration may be needed if the allocated UL resource cannot support the UL traffic load. In another example, reconfiguration may be needed if the allocated DL resource cannot support the DL traffic load. Furthermore, a reconfiguration may be used to adapt to a traffic load with a better matching TDD UL/DL allocation. For instance, a reconfiguration may be needed if a current TDD UL/DL configuration does not match the UL-to-DL traffic ratio.

In order to better adapt to traffic conditions, dynamic subframe type conversion procedures may be supported aside from the system information change. Dynamic subframe type conversion may maintain backward compatibility (for legacy UEs, for example) and provide more flexibility (for UEs operating in accordance with Release 12 specifications and beyond, for example) with fast subframe modifications based on real-time traffic changes. Furthermore, different TDD UL/DL configurations in neighboring cells may be supported (in Release 11, for example) in a temporary or persistent manner with co-channel interference mitigation techniques. The different TDD UL/DL configurations may be caused by different initial network configurations and/or by dynamic subframe type conversion with traffic adaptation. The purpose of dynamic subframe type conversion may not be limited to traffic conditions. For example, there may be one or multiple factors that may be considered when deciding to use dynamic subframe type conversion (e.g., interference mitigation, overhead reduction, mobility, an operator's decision, etc.).

In Releases 8, 9, 10 and 11, the TDD UL/DL associations on PDSCH HARQ-ACK, PUSCH scheduling and PUSCH HARQ-ACK are defined by the TDD UL/DL configuration. All legacy UEs in the network follow the same PDSCH HARQ-ACK report associations defined by the given TDD UL/DL configuration. Similarly, all legacy UEs in the network follow the same PUSCH scheduling and PUSCH HARQ-ACK report associations defined by the given TDD UL/DL configuration.

Dynamic subframe type conversion provides an approach that may separate PDSCH and PUSCH timing associations based on different reference UL/DL configurations. For example, a network (e.g., one or more UEs and one or more eNBs) may be configured to allow dynamic subframe type conversion based on traffic adaptation (aside from the default TDD UL/DL configuration as in Releases 8, 9, 10 and 11). For instance, a UE that is configured to allow dynamic subframe type conversion may utilize one reference UL/DL configuration for PDSCH HARQ-ACK association (e.g., a DL-reference UL/DL configuration) and another reference UL/DL configuration for PUSCH scheduling and PUSCH HARQ-ACK association (e.g., a UL-reference UL/DL configuration), while the UE has knowledge of a default TDD UL/DL configuration (e.g., a TDD UL/DL configuration or a first UL/DL configuration). Therefore, because a serving cell with dynamic subframe type conversion may dynamically change its TDD UL/DL configuration, the DL-reference UL/DL configuration and UL-reference UL/DL configuration may be specified.

Subframe bundling uses consecutive UL subframes for PUSCH transmission. The systems and methods described herein provide various implementations to determine the PUSCH HARQ timing and the consecutive UL subframes used to perform subframe bundling when a UE is configured with dynamic subframe type conversion.

Various examples of the systems and methods disclosed herein are now described with reference to the Figures, where like reference numbers may indicate functionally similar elements. The systems and methods as generally described and illustrated in the Figures herein could be arranged and designed in a wide variety of different implementations. Thus, the following more detailed description of several implementations, as represented in the Figures, is not intended to limit scope as claimed, but is merely representative of the systems and methods.

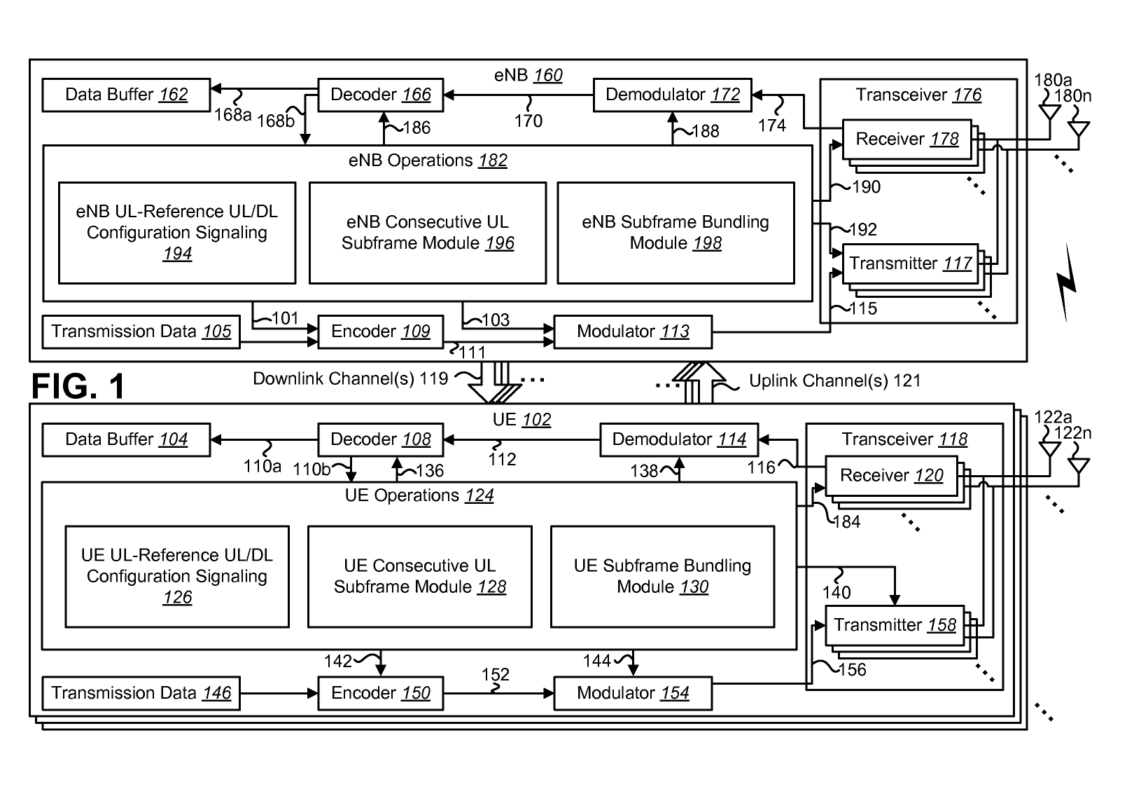

FIG. 1 is a block diagram illustrating one implementation of one or more eNBs 160 and one or more UEs 102 in which systems and methods for subframe bundling may be implemented. The one or more UEs 102 communicate with one or more eNBs 160 using one or more antennas 122a-n. For example, a UE 102 transmits electromagnetic signals to the eNB 160 and receives electromagnetic signals from the eNB 160 using the one or more antennas 122a-n. The eNB 160 communicates with the UE 102 using one or more antennas 180a-n.

The UE 102 and the eNB 160 may use one or more channels 119, 121 to communicate with each other. For example, a UE 102 may transmit information or data to the eNB 160 using one or more uplink channels 121. Examples of uplink channels 121 include a physical uplink control channel (PUCCH) and a PUSCH, etc. The one or more eNBs 160 may also transmit information or data to the one or more UEs 102 using one or more downlink channels 119, for instance. Examples of downlink channels 119 include a PDCCH, a PDSCH, etc. Other kinds of channels may be used.

Each of the one or more UEs 102 may include one or more transceivers 118, one or more demodulators 114, one or more decoders 108, one or more encoders 150, one or more modulators 154, a data buffer 104 and a UE operations module 124. For example, one or more reception and/or transmission paths may be implemented in the UE 102. For convenience, only a single transceiver 118, decoder 108, demodulator 114, encoder 150 and modulator 154 are illustrated in the UE 102, though multiple parallel elements (e.g., transceivers 118, decoders 108, demodulators 114, encoders 150 and modulators 154) may be implemented.

The transceiver 118 may include one or more receivers 120 and one or more transmitters 158. The one or more receivers 120 may receive signals from the eNB 160 using one or more antennas 122a-n. For example, the receiver 120 may receive and downconvert signals to produce one or more received signals 116. The one or more received signals 116 may be provided to a demodulator 114. The one or more transmitters 158 may transmit signals to the eNB 160 using one or more antennas 122a-n. For example, the one or more transmitters 158 may upconvert and transmit one or more modulated signals 156.

The demodulator 114 may demodulate the one or more received signals 116 to produce one or more demodulated signals 112. The one or more demodulated signals 112 may be provided to the decoder 108. The UE 102 may use the decoder 108 to decode signals. The decoder 108 may produce one or more decoded signals 110a-b. For example, a first UE-decoded signal 110a may comprise received payload data, which may be stored in a data buffer 104. A second UE-decoded signal 110b may comprise overhead data and/or control data. For example, the second UE-decoded signal 110b may provide data that may be used by the UE operations module 124 to perform one or more operations.

As used herein, the term “module” may mean that a particular element or component may be implemented in hardware, software or a combination of hardware and software. However, it should be noted that any element denoted as a “module” herein may alternatively be implemented in hardware. For example, the UE operations module 124 may be implemented in hardware, software or a combination of both.

In general, the UE operations module 124 may enable the UE 102 to communicate with the one or more eNBs 160. The UE operations module 124 may include a UE UL-reference UL/DL configuration signaling module 126, a UE consecutive UL subframe module 128 and a UE subframe bundling module 130.

The UE UL-reference UL/DL configuration signaling module 126 may receive signaling that indicates a UL-reference UL/DL configuration for a serving cell. In one implementation, the UE UL-reference UL/DL configuration signaling module 126 may receive RRC dedicated signaling. For example, the RRC dedicated signaling may include a radio resource configuration (RRC) message (e.g., RadioResourceConfigDedicated, RadioResourceConfiguDediatedSCell-r10). The UE operations module 124 may receive the RRC common signaling. The RRC common signaling may include a system information block (e.g., SystemInformationBlockType1) or a radio resource configuration (RRC) message (e.g., RadioResourceConfigCommon or RadioResourceConfigCommonSCell-r10). The UL-reference UL/DL configuration of the serving cell may be signaled in the RRC dedicated signaling. The first UL/DL configuration may be signaled in the RRC common signaling.

UL/DL configuration of the UL-reference UL/DL configuration of the serving cell may be the same or different than UL/DL configuration of a TDD UL/DL configuration (e.g., a first UL/DL configuration) of the serving cell. The UL-reference UL/DL configuration of the serving cell may be signaled in a different information element than the TDD UL/DL configuration of the serving cell. The UE UL-reference UL/DL configuration signaling module 126 may determine the UL-reference UL/DL configuration based on the signaling. In one implementation, the UE UL-reference UL/DL configuration signaling module 126 may obtain the UL-reference UL/DL configuration directly from the signaling. In another implementation, the UE UL-reference UL/DL configuration signaling module 126 may receive signaling for a second UL/DL configuration, and the UE UL-reference UL/DL configuration signaling module 126 may determine the UL-reference UL/DL configuration based on the pair of the first UL/DL configuration and the second UL/DL configuration.

The UE consecutive UL subframe module 128 may determine consecutive UL subframes based on the UL subframes of the UL-reference UL/DL configuration. The consecutive UL subframes may include a number of UL subframes corresponding to a TTI bundle size. In one implementation, when subframe bundling is configured, a parameter TTI_BUNDLE_SIZE may provide the number of subframes (e.g., TTIs) of a subframe bundle.

A TDD subframe may be of a particular subframe type (e.g., a downlink subframe, an uplink subframe, a special subframe that is not able to be used for PUSCH transmission or a special subframe that is able to be used for PUSCH transmission). With dynamic subframe type conversion, some subframes may be flexible and convertible (e.g., flexible subframes) and can be used as either a downlink subframe, an uplink subframe or a special subframe. The UE consecutive UL subframe module 128 may determine consecutive UL subframes. A number of consecutive UL subframes in a given UL-reference UL/DL configuration may be grouped to form a subframe bundle. The consecutive UL subframes may be determined based on when a UL grant for an initial PUSCH transmission is transmitted. A flexible subframe may be included in the consecutive UL subframes.

The UE subframe bundling module 130 may perform a subframe bundling operation based on the consecutive UL subframes. For example, the UE subframe bundling module 130 may send PUSCH transmissions in the consecutive UL subframes. The UE subframe bundling module 130 may send PUSCH with a redundancy version (e.g., a starting point of coded bits in a circular buffer) to the eNB 160 in each of the consecutive UL subframes. The UE 102 may then receive a PHICH transmission (e.g., a PUSCH HARQ transmission) from the eNB 160 that instructs the UE 102 on whether a retransmission should be performed.

In a first implementation, a PUSCH transmission in the flexible subframe may not occur because the flexible subframe is not a UL subframe of the UL-reference UL/DL configuration. This UL-reference UL/DL configuration of subframe bundling may be different than UL-reference UL/DL configuration of normal operation. Therefore, in this implementation, the PUSCH transmission in the flexible subframe may not occur even if the flexible subframe is operating as a UL subframe or a special subframe that is used for PUSCH transmission. The PUSCH transmission may occur only in the fixed subframe (e.g., non-flexible subframe). The consecutive UL subframes may only include UL subframes of the UL-reference UL/DL configuration. The consecutive UL subframes may only include UL subframes of the non-flexible subframes.

In a second implementation, the UE subframe bundling module 130 may drop a PUSCH transmission in a subframe in a bundle if the subframe is determined to be a non-PUSCH transmission subframe. The consecutive UL subframes may include UL subframes of the flexible and non-flexible subframes (even non-PUSCH transmission subframes). The non-PUSCH transmission subframe may be a downlink subframe or a special subframe that is not used for PUSCH transmission. In one case, the UE subframe bundling module 130 may determine whether a subframe is a non-PUSCH transmission subframe based on physical (PHY) layer signaling. In another case, the UE subframe bundling module 130 may determine whether the subframe is a non-PUSCH transmission subframe based on a predetermined UL/DL configuration. In yet another case, the UE subframe bundling module 130 may determine whether the subframe is a non-PUSCH transmission subframe based on whether a UL grant and/or a PHICH instructing PUSCH transmission for the subframe has been received.

The UE operations module 124 may provide information 184 to the one or more receivers 120. For example, the UE operations module 124 may inform the receiver(s) 120 when to send retransmissions. In some implementations, this may be based on the consecutive UL subframes determined based on the UL-reference UL/DL configuration.

The UE operations module 124 may provide information 138 to the demodulator 114. For example, the UE operations module 124 may inform the demodulator 114 of a modulation pattern for PUSCH transmissions to the eNB 160.

The UE operations module 124 may provide information 136 to the decoder 108. For example, the UE operations module 124 may inform the decoder 108 of an anticipated encoding for transmissions from the eNB 160.

The UE operations module 124 may provide information 142 to the encoder 150. The information 142 may include data to be encoded and/or instructions for encoding. For example, the UE operations module 124 may instruct the encoder 150 to encode transmission data 146 and/or other information 142. The other information 142 may include PUSCH information.

The encoder 150 may encode transmission data 146 and/or other information 142 provided by the UE operations module 124. For example, encoding the data 146 and/or other information 142 may involve error detection and/or correction coding, mapping data to space, time and/or frequency resources for transmission, multiplexing, etc. The encoder 150 may provide encoded data 152 to the modulator 154.

The UE operations module 124 may provide information 144 to the modulator 154. For example, the UE operations module 124 may inform the modulator 154 of a modulation type (e.g., constellation mapping) to be used for transmissions to the eNB 160. The modulator 154 may modulate the encoded data 152 to provide one or more modulated signals 156 to the one or more transmitters 158.

The UE operations module 124 may provide information 140 to the one or more transmitters 158. This information 140 may include instructions for the one or more transmitters 158. For example, the UE operations module 124 may instruct the one or more transmitters 158 when to transmit a signal to the eNB 160. For instance, the one or more transmitters 158 may transmit during a UL subframe. The one or more transmitters 158 may upconvert and transmit the modulated signal(s) 156 to one or more eNBs 160.

The eNB 160 may include one or more transceivers 176, one or more demodulators 172, one or more decoders 166, one or more encoders 109, one or more modulators 113, a data buffer 162 and an eNB operations module 182. For example, one or more reception and/or transmission paths may be implemented in an eNB 160. For convenience, only a single transceiver 176, decoder 166, demodulator 172, encoder 109 and modulator 113 are illustrated in the eNB 160, though multiple parallel elements (e.g., transceivers 176, decoders 166, demodulators 172, encoders 109 and modulators 113) may be implemented.

The transceiver 176 may include one or more receivers 178 and one or more transmitters 117. The one or more receivers 178 may receive signals from the UE 102 using one or more antennas 180a-n. For example, the receiver 178 may receive and downconvert signals to produce one or more received signals 174. The one or more received signals 174 may be provided to a demodulator 172. The one or more transmitters 117 may transmit signals to the UE 102 using one or more antennas 180a-n. For example, the one or more transmitters 117 may upconvert and transmit one or more modulated signals 115.

The demodulator 172 may demodulate the one or more received signals 174 to produce one or more demodulated signals 170. The one or more demodulated signals 170 may be provided to the decoder 166. The eNB 160 may use the decoder 166 to decode signals. The decoder 166 may produce one or more decoded signals 168a-b. For example, a first eNB-decoded signal 168a may comprise received payload data, which may be stored in a data buffer 162. A second eNB-decoded signal 168b may comprise overhead data and/or control data. For example, the second eNB-decoded signal 168b may provide data (e.g., PDSCH HARQ-ACK information) that may be used by the eNB operations module 182 to perform one or more operations.

In general, the eNB operations module 182 may enable the eNB 160 to communicate with the one or more UEs 102. The eNB operations module 182 may include an eNB UL-reference UL/DL configuration signaling module 194, an eNB consecutive UL subframe module 196 and an eNB subframe bundling module 198.

The eNB UL-reference UL/DL configuration signaling module 194 may send signaling that indicates a UL-reference UL/DL configuration for a serving cell. In one implementation, the eNB UL-reference UL/DL configuration signaling module 194 may send RRC dedicated signaling. For example, the RRC dedicated signaling may include a radio resource configuration (RRC) message (e.g., RadioResourceConfigDedicated, RadioResourceConfiguDediatedSCell-r10). The eNB operations module 124 may send the RRC common signaling. The RRC common signaling may include a system information block (e.g., SystemInformationBlockType1) or a radio resource configuration (RRC) message (e.g., RadioResourceConfigCommon or RadioResourceConfigCommonSCell-r10). The UL-reference UL/DL configuration of the serving cell may be signaled in the RRC dedicated signaling. The UL-reference UL/DL configuration of the serving cell may be signaled in the RRC common signaling. The first UL/DL configuration may be signaled in the RRC common signaling.

UL/DL configuration of the UL-reference UL/DL configuration of the serving cell may be the same or different than UL/DL configuration of the first UL/DL configuration of the serving cell. The UL-reference UL/DL configuration of the serving cell may be signaled in different information element than the first UL/DL configuration of the serving cell. The eNB UL-reference UL/DL configuration signaling module 194 may indicate the UL-reference UL/DL configuration based on the signaling. In one implementation, the eNB UL-reference UL/DL configuration signaling module 194 may indicate the UL-reference UL/DL configuration directly in the signaling. In another implementation, the eNB UL-reference UL/DL configuration signaling module 194 may send signaling for a second UL/DL configuration, which may be used to determine the UL-reference UL/DL configuration based on the pair of the first UL/DL configuration and the second UL/DL configuration.

The eNB consecutive UL subframe module 196 may determine consecutive UL subframes based on the UL subframes of the UL-reference UL/DL configuration. The consecutive UL subframes may include a number of UL subframes corresponding to a TTI bundle size. In one implementation, when subframe bundling is configured, a parameter TTI_BUNDLE_SIZE may provide the number of subframes (e.g., TTIs) of a subframe bundle. A number of consecutive UL subframes in the UL-reference UL/DL configuration may be grouped to form a subframe bundle. The eNB consecutive UL subframe module 196 may determine the consecutive UL subframes based on when a UL grant for an initial PUSCH transmission is transmitted. A flexible subframe may be included in the consecutive UL subframes.

The eNB subframe bundling module 198 may perform a subframe bundling operation based on the consecutive UL subframes. For example, the eNB subframe bundling module 198 may receive PUSCH transmissions in the consecutive UL subframes. The eNB subframe bundling module 198 may receive PUSCH with a redundancy version (e.g., a starting point of coded bits in a circular buffer for the UE 102) from the UE 102 in each of the consecutive UL subframes. The eNB subframe bundling module 198 may then send a PHICH transmission (e.g., a PUSCH HARQ transmission) to the UE 102 that instructs the UE 102 on whether a retransmission should be performed.

In a first implementation, a PUSCH transmission in the flexible subframe may not occur because the flexible subframe is not a UL subframe of the UL-reference UL/DL configuration. This UL-reference UL/DL configuration of subframe bundling may be different than UL-reference UL/DL configuration of normal operation. Therefore, in this implementation, a PUSCH transmission in the flexible subframe may not occur even if the flexible subframe is operating as a UL subframe or a special subframe that is used for PUSCH transmission. The PUSCH transmission may occur only in the fixed subframe (e.g., non-flexible subframe). The consecutive UL subframes may only include UL subframes of the UL-reference UL/DL configuration. The consecutive UL subframes may only include UL subframes of the non-flexible subframes.

In a second implementation, the eNB subframe bundling module 198 may assume that a PUSCH transmission in a subframe in a bundle is dropped if the subframe is determined to be a non-PUSCH transmission subframe. The consecutive UL subframes may include UL subframes of the flexible and non-flexible subframes (even non-PUSCH transmission subframes). In one case, the eNB subframe bundling module 198 may determine whether a subframe is a non-PUSCH transmission subframe based on physical (PHY) layer signaling. In another case, the eNB subframe bundling module 198 may determine whether the subframe is a non-PUSCH transmission subframe based on a predetermined UL/DL configuration. In yet another case, the eNB subframe bundling module 198 may determine whether the subframe is a non-PUSCH transmission subframe based on whether a UL grant and/or a PHICH instructing PUSCH transmission for the subframe has been transmitted.

The eNB operations module 182 may provide information 190 to the one or more receivers 178. For example, the eNB operations module 182 may inform the receiver(s) 178 when or when not to receive PUSCH information based on the consecutive UL subframes.

The eNB operations module 182 may provide information 188 to the demodulator 172. For example, the eNB operations module 182 may inform the demodulator 172 of a modulation pattern anticipated for transmissions from the UE(s) 102.

The eNB operations module 182 may provide information 186 to the decoder 166. For example, the eNB operations module 182 may inform the decoder 166 of an anticipated encoding for transmissions from the UE(s) 102.

The eNB operations module 182 may provide information 101 to the encoder 109. The information 101 may include data to be encoded and/or instructions for encoding. For example, the eNB operations module 182 may instruct the encoder 109 to encode transmission data 105 and/or other information 101.

The encoder 109 may encode transmission data 105 and/or other information 101 provided by the eNB operations module 182. For example, encoding the data 105 and/or other information 101 may involve error detection and/or correction coding, mapping data to space, time and/or frequency resources for transmission, multiplexing, etc. The encoder 109 may provide encoded data 111 to the modulator 113. The transmission data 105 may include network data to be relayed to the UE 102.

The eNB operations module 182 may provide information 103 to the modulator 113. This information 103 may include instructions for the modulator 113. For example, the eNB operations module 182 may inform the modulator 113 of a modulation type (e.g., constellation mapping) to be used for transmissions to the UE(s) 102. The modulator 113 may modulate the encoded data 111 to provide one or more modulated signals 115 to the one or more transmitters 117.

The eNB operations module 182 may provide information 192 to the one or more transmitters 117. This information 192 may include instructions for the one or more transmitters 117. For example, the eNB operations module 182 may instruct the one or more transmitters 117 when to (or when not to) transmit a signal to the UE(s) 102. The one or more transmitters 117 may upconvert and transmit the modulated signal(s) 115 to one or more UEs 102.

It should be noted that a DL subframe may be transmitted from the eNB 160 to one or more UEs 102 and that a UL subframe may be transmitted from one or more UEs 102 to the eNB 160. Furthermore, both the eNB 160 and the one or more UEs 102 may transmit data in a standard special subframe.

It should also be noted that one or more of the elements or parts thereof included in the eNB(s) 160 and UE(s) 102 may be implemented in hardware. For example, one or more of these elements or parts thereof may be implemented as a chip, circuitry or hardware components, etc. It should also be noted that one or more of the functions or methods described herein may be implemented in and/or performed using hardware. For example, one or more of the methods described herein may be implemented in and/or realized using a chipset, an application-specific integrated circuit (ASIC), a large-scale integrated (LSI) circuit or integrated circuit, etc.

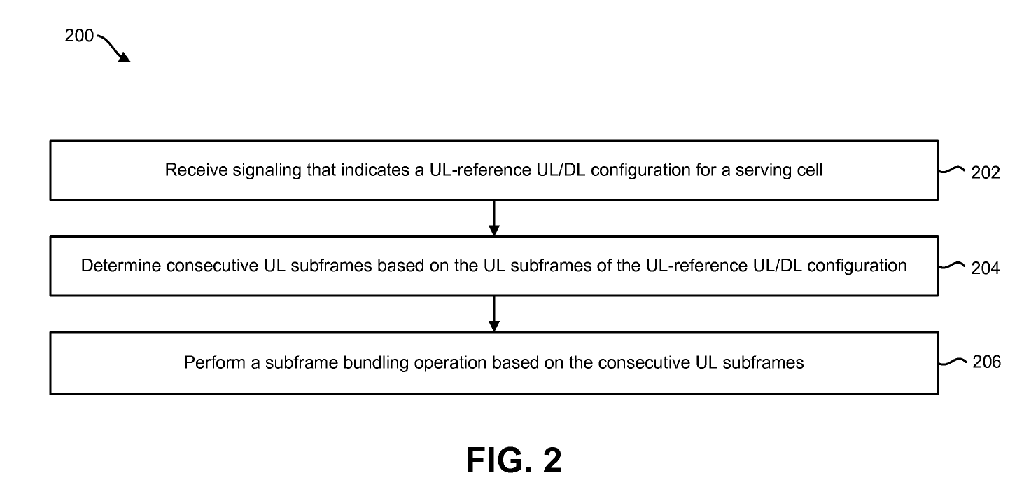

FIG. 2 is a flow diagram illustrating one implementation of a method 200 for subframe bundling by a UE 102. The UE 102 may be configured with dynamic subframe type conversion and subframe bundling. The UE 102 may be configured with a first UL/DL configuration for a serving cell. The first UL/DL configuration of the serving cell may be signaled in a system information block (e.g., SystemInformationBlockType1) or a radio resource configuration (RRC) message (e.g., RadioResourceConfigCommon or RadioResourceConfigCommonSCell-r10). The serving cell may support dynamic subframe type conversion.

The UE 102 may receive 202 signaling that indicates a UL-reference UL/DL configuration for a serving cell. In one implementation, the UE 102 may receive 202 RRC dedicated signaling. For example, the RRC dedicated signaling may include a radio resource configuration (RRC) message (e.g., RadioResourceConfigDedicated, RadioResourceConfiguDediatedSCell-r10). The UL-reference UL/DL configuration of the serving cell may be signaled in the RRC dedicated signaling. The UL-reference UL/DL configuration of the serving cell may be signaled in the RRC common signaling.

UL/DL configuration of the UL-reference UL/DL configuration of the serving cell may be the same or different than UL/DL configuration of the first UL/DL configuration of the serving cell. The UL-reference UL/DL configuration of the serving cell may be signaled in different information element than the first UL/DL configuration of the serving cell. The UE 102 may determine the UL-reference UL/DL configuration based on the signaling. In one implementation, the UE 102 may obtain the UL-reference UL/DL configuration directly from the signaling. In another implementation, the UE 102 may receive 202 signaling for a second UL/DL configuration, and the UE 102 may determine the UL-reference UL/DL configuration based on the pair of the first UL/DL configuration and the second UL/DL configuration. For example, the UE 102 may determine the UL-reference UL/DL configuration by using Table (3) below, where the “Other serving cell TDD UL/DL configuration” refers to the second UL/DL configuration and the “Serving cell TDD UL/DL configuration” refers to the first UL/DL configuration. In another example, the UE 102 may determine the UL-reference UL/DL configuration by using a new table to output the UL-reference UL/DL configuration from the first UL/DL configuration or the pair of the first UL/DL configuration and the second UL/DL configuration.

The UE 102 may determine 204 consecutive UL subframes based on the UL subframes of the UL-reference UL/DL configuration. The consecutive UL subframes may include a number of UL subframes corresponding to a TTI bundle size. In one implementation, when subframe bundling is configured, a parameter TTI_BUNDLE_SIZE may provide the number of subframes (e.g., TTIs) of a subframe bundle.

A TDD subframe may be of a particular subframe type (e.g., a downlink subframe, an uplink subframe, a special subframe that is not able to be used for PUSCH transmission or a special subframe that is able to be used for PUSCH transmission). With dynamic subframe type conversion, some subframes may be flexible and convertible (e.g., flexible subframes) and can be used as either a downlink subframe, an uplink subframe or a special subframe. A number of consecutive UL subframes in a given UL-reference UL/DL configuration may be grouped to form a subframe bundle. The consecutive UL subframes may be determined 204 based on when a UL grant for an initial PUSCH transmission is transmitted. A flexible subframe may be included in the consecutive UL subframes.

The UE 102 may perform 206 a subframe bundling operation based on the consecutive UL subframes. For example, the UE 102 may send PUSCH transmissions in the consecutive UL subframes while the timing of the initial PUSCH transmission is determined based on the timing of the UL grant. The UE 102 may send PUSCH with a redundancy version (e.g., a starting point of coded bits in a circular buffer) to an eNB 160 in each of the consecutive UL subframes. The redundancy version index may be incremented in every UL subframe. The UE 102 may then receive a PHICH transmission (e.g., a PUSCH HARQ transmission) from the eNB 160 that instructs the UE 102 on whether a retransmission should be performed.

In a first implementation, a PUSCH transmission in the flexible subframe may not occur because the flexible subframe is not a UL subframe of the UL-reference UL/DL configuration. This UL-reference UL/DL configuration of subframe bundling may be different than UL-reference UL/DL configuration of normal operation. Therefore, in this implementation, the PUSCH transmission in the flexible subframe may not occur even if the flexible subframe is operating as a UL subframe or a special subframe that is used for PUSCH transmission. The PUSCH transmission may occur only in the fixed subframe (e.g., non-flexible subframe). The consecutive UL subframes may only include UL subframes of the UL-reference UL/DL configuration. The consecutive UL subframes may only include UL subframes of the non-flexible subframes.

In a second implementation, the UE 102 may drop a PUSCH transmission in a subframe in a bundle if the subframe is determined to be a non-PUSCH transmission subframe. The consecutive UL subframes may include UL subframes of the flexible and non-flexible subframes (even non-PUSCH transmission subframes). The non-PUSCH transmission subframe may be a downlink subframe or a special subframe that is not used for PUSCH transmission. In one case, the UE 102 may determine whether a subframe is a non-PUSCH transmission subframe based on physical (PHY) layer signaling. In another case, the UE 102 may determine whether the subframe is a non-PUSCH transmission subframe based on a predetermined UL/DL configuration. In yet another case, the UE 102 may determine whether the subframe is a non-PUSCH transmission subframe based on whether a UL grant and/or a PHICH instructing PUSCH transmission for the subframe has been received.

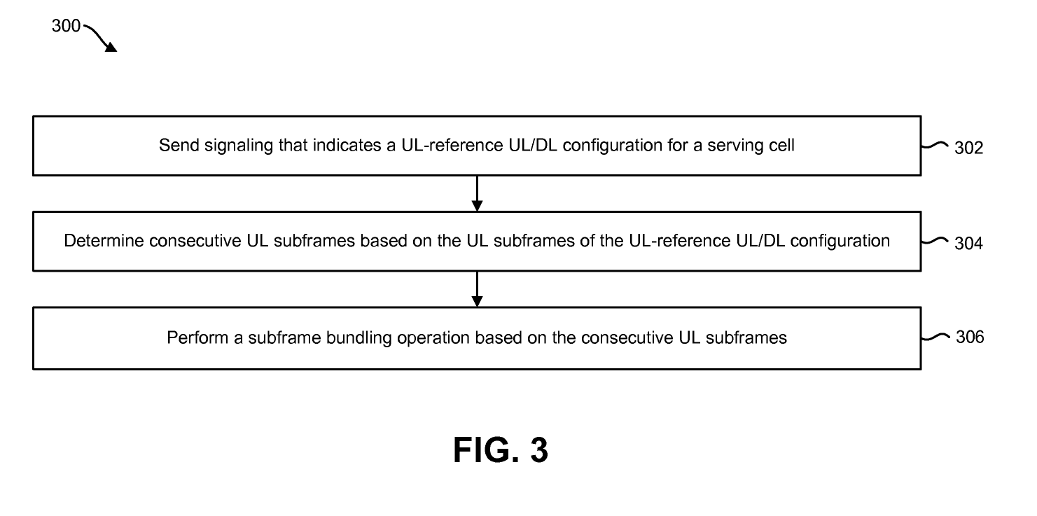

FIG. 3 is a flow diagram illustrating one implementation of a method 300 for configuration signaling by an eNB 160. The eNB 160 may be configured with dynamic subframe type conversion and subframe bundling. The eNB 160 may be configured with a first UL/DL configuration for a serving cell. The first UL/DL configuration of the serving cell may be signaled in a system information block (e.g., SystemInformationBlockType1) or a radio resource configuration (RRC) message (e.g., RadioResourceConfigCommon or RadioResourceConfigCommonSCell-r10). The serving cell may support dynamic subframe type conversion.

The eNB 160 may send 302 signaling that indicates a UL-reference UL/DL configuration for a serving cell. In one implementation, the eNB 160 may send 302 RRC dedicated signaling. For example, the RRC dedicated signaling may include a radio resource configuration (RRC) message (e.g., RadioResourceConfigDedicated, RadioResourceConfiguDediatedSCell-r10). The UL-reference UL/DL configuration of the serving cell may be signaled in the RRC dedicated signaling. The UL-reference UL/DL configuration of the serving cell may be signaled in the RRC common signaling.

UL/DL configuration of the UL-reference UL/DL configuration of the serving cell may be the same or different than UL/DL configuration of the TDD UL/DL configuration of the serving cell. The UL-reference UL/DL configuration of the serving cell may be signaled in different information element than the TDD UL/DL configuration of the serving cell. The eNB 160 may indicate the UL-reference UL/DL configuration based on the signaling. In one implementation, the eNB 160 may indicate the UL-reference UL/DL configuration directly in the signaling. In another implementation, the eNB 160 may send 302 signaling for a second UL/DL configuration, which may be used to determine the UL-reference UL/DL configuration based on the pair of the first UL/DL configuration and the second UL/DL configuration.

The eNB 160 may determine 304 consecutive UL subframes based on the UL subframes of the UL-reference UL/DL configuration. The consecutive UL subframes may include a number of UL subframes corresponding to a TTI bundle size. In one implementation, when subframe bundling is configured, a parameter TTI_BUNDLE_SIZE may provide the number of subframes (e.g., TTIs) of a subframe bundle. A number of consecutive UL subframes in the UL-reference UL/DL configuration may be grouped to form a subframe bundle. The consecutive UL subframes may be determined 304 based on when a UL grant for an initial PUSCH transmission is transmitted. A flexible subframe may be included in the consecutive UL subframes.

The eNB 160 may perform 306 a subframe bundling operation based on the consecutive UL subframes. For example, the eNB 160 may receive PUSCH transmissions in the consecutive UL subframes while the timing of the initial PUSCH transmission is determined based on the timing of UL grant. The eNB 160 may receive a redundancy version (e.g., a starting point of coded bits in a circular buffer for the UE 102) from a UE 102 in each of the consecutive UL subframes. The redundancy version index may be incremented in every UL subframe. The eNB 160 may then send a PHICH transmission (e.g., a PUSCH HARQ transmission) to the UE 102 that instructs the UE 102 on whether a retransmission should be performed.

In a first implementation, a PUSCH transmission in the flexible subframe may not occur because the flexible subframe is not a UL subframe of the UL-reference UL/DL configuration. This UL-reference UL/DL configuration of subframe bundling may be different than UL-reference UL/DL configuration of normal operation. Therefore, in this implementation, a PUSCH transmission in the flexible subframe may not occur even if the flexible subframe is operating as a UL subframe or a special subframe that is used for PUSCH transmission. The PUSCH transmission may occur only in the fixed subframe (e.g., non-flexible subframe). The consecutive UL subframes may only include UL subframes of the UL-reference UL/DL configuration. The consecutive UL subframes may only include UL subframes of the non-flexible subframes.

In a second implementation, the eNB 160 may assume that a PUSCH transmission in a subframe in a bundle is dropped if the subframe is determined to be a non-PUSCH transmission subframe. The consecutive UL subframes may include UL subframes of the flexible and non-flexible subframes (even non-PUSCH transmission subframes). The non-PUSCH transmission subframe may be a downlink subframe or a special subframe that is not used for PUSCH transmission. In one case, the eNB 160 may determine whether a subframe is a non-PUSCH transmission subframe based on physical (PHY) layer signaling. In another case, the eNB 160 may determine whether the subframe is a non-PUSCH transmission subframe based on a predetermined UL/DL configuration. In yet another case, the eNB 160 may determine whether the subframe is a non-PUSCH transmission subframe based on whether a UL grant and/or a PHICH instructing PUSCH transmission for the subframe has been transmitted.

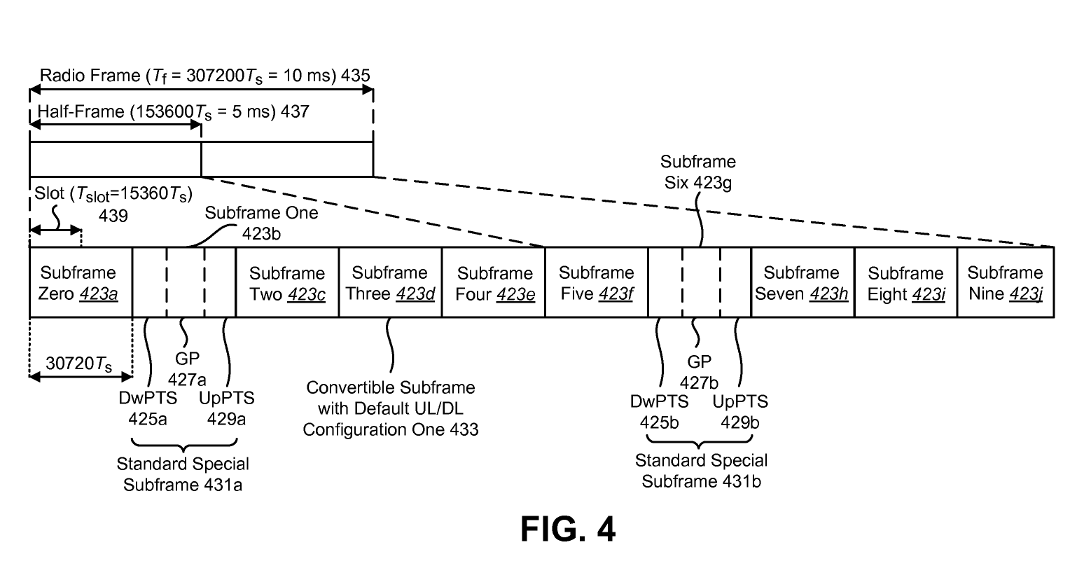

FIG. 4 is a diagram illustrating one example of a radio frame 435 that may be used in accordance with the systems and methods disclosed herein. This radio frame 435 structure illustrates a TDD structure. Each radio frame 435 may have a length of T_{f}=307200·Tₛ=10 ms, where T_{f} is a radio frame 435 duration and Tₛ is a time unit equal to

$$\frac{1}{( 15000 \times 2048 )}$$

seconds. The radio frame 435 may include two half-frames 437, each having a length of 153600·Tₛ=5 ms. Each half-frame 437 may include five subframes 423a-e, 423f-j each having a length of 30720·Tₛ=1 ms.

TDD UL/DL configurations 0-6 are given below in Table (1) (from Table 4.2-2 in 3GPP TS 36.211). TDD UL/DL configurations with both 5 ms and 10 ms downlink-to-uplink switch-point periodicity may be supported. In particular, seven TDD UL/DL configurations are specified in 3GPP specifications, as shown in Table (1) below. In Table (1), “D” denotes a downlink subframe, “S” denotes a special subframe and “U” denotes an uplink subframe.

TABLE (1)

| TDD UL/DL | Downlink-to-Uplink | | | | | | | | | | |
|---|---|---|---|---|---|---|---|---|---|---|---|
| Configuration | Switch-Point | Subframe Number | | | | | | | | | |
| Number | Periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

In Table (1) above, for each subframe in a radio frame, “D” indicates that the subframe is reserved for downlink transmissions, “U” indicates that the subframe is reserved for uplink transmissions and “S” indicates a special subframe with three fields: a downlink pilot time slot (DwPTS), a guard period (GP) and an uplink pilot time slot (UpPTS). The length of DwPTS and UpPTS is given in Table (2) (from Table 4.2-1 of 3GPP TS 36.211) subject to the total length of DwPTS, GP and UpPTS being equal to 30720·Tₛ=1 ms. Table (2) illustrates several configurations of (standard) special subframes. Each subframe i is defined as two slots, 2i and 2i+1 of length Tₛᵢₒₜ=15360·Tₛ=0.5 ms in each subframe. In Table (2), “cyclic prefix” is abbreviated as “CP” and “configuration” is abbreviated as “Config” for convenience.

TABLE (2)

| | Normal CP in downlink | | | Extended CP in downlink | | |
|---|---|---|---|---|---|---|
| | | UpPTS | | | UpPTS | |
| Special | | Normal | Extended | | Normal | Extended |
| Subframe | | CP in | CP in | | CP in | CP in |
| Config | DwPTS | uplink | uplink | DwPTS | uplink | uplink |
| 0 | 6592 · Tₛ | 2192 · Tₛ | 2560 · Tₛ | 7680 · Tₛ | 2192 · Tₛ | 2560 · Tₛ |
| 1 | 19760 · Tₛ | | | 20480 · Tₛ | | |
| 2 | 21952 · Tₛ | | | 23040 · Tₛ | | |
| 3 | 24144 · Tₛ | | | 25600 · Tₛ | | |
| 4 | 26336 · Tₛ | | | 7680 · Tₛ | 4384 · Tₛ | 5120 · Tₛ |
| 5 | 6592 · Tₛ | 4384 · Tₛ | 5120 · Tₛ | 20480 · Tₛ | | |
| 6 | 19760 · Tₛ | | | 23040 · Tₛ | | |
| 7 | 21952 · Tₛ | | | 12800 · T_{S} | | |
| 8 | 24144 · Tₛ | | | — | — | — |
| 9 | 13168 · T_{S} | | | — | — | — |

TDD UL/DL configurations with both 5 ms and 10 ms downlink-to-uplink switch-point periodicity are supported. In the case of 5 ms downlink-to-uplink switch-point periodicity, the special subframe exists in both half-frames. In the case of 10 ms downlink-to-uplink switch-point periodicity, the special subframe exists in the first half-frame only. Subframes 0 and 5 and DwPTS may be reserved for downlink transmission. UpPTS and the subframe immediately following the special subframe may be reserved for uplink transmission.

In accordance with the systems and methods disclosed herein, some types of subframes 423 that may be used include a downlink subframe, an uplink subframe and a special subframe 431. In the example illustrated in FIG. 4, which has a 5 ms periodicity, two standard special subframes 431a-b are included in the radio frame 435.

The first special subframe 431a includes a downlink pilot time slot (DwPTS) 425a, a guard period (GP) 427a and an uplink pilot time slot (UpPTS) 429a. In this example, the first standard special subframe 431a is included in subframe one 423b. The second standard special subframe 431b includes a downlink pilot time slot (DwPTS) 425b, a guard period (GP) 427b and an uplink pilot time slot (UpPTS) 429b. In this example, the second standard special subframe 431b is included in subframe six 423g. The length of the DwPTS 425a-b and UpPTS 429a-b may be given by Table 4.2-1 of 3GPP TS 36.211 (illustrated in Table (2) above) subject to the total length of each set of DwPTS 425, GP 427 and UpPTS 429 being equal to 30720·Tₛ=1 ms.

Each subframe i 423a-j (where i denotes a subframe ranging from subframe zero 423a (e.g., 0) to subframe nine 423j (e.g., 9) in this example) is defined as two slots, 2i and 2i+1 of length Tₛₗₒₜ=15360·Tₛ=0.5 ms in each subframe 423. For example, subframe zero (e.g., 0) 423a may include two slots, including a first slot 439.

TDD UL/DL configurations with both 5 ms and 10 ms downlink-to-uplink switch-point periodicity may be used in accordance with the systems and methods disclosed herein. FIG. 4 illustrates one example of a radio frame 435 with 5 ms switch-point periodicity. In the case of 5 ms downlink-to-uplink switch-point periodicity, each half-frame 437 includes a standard special subframe 431a-b. In the case of 10 ms downlink-to-uplink switch-point periodicity, a special subframe may exist in the first half-frame 437 only.

Subframe zero (e.g., 0) 423a and subframe five (e.g., 5) 423f and DwPTS 425a-b may be reserved for DL transmission. The UpPTS 429a-b and the subframe(s) immediately following the standard special subframe(s) 431a-b (e.g., subframe two 423c and subframe seven 423h) may be reserved for UL transmission. In one implementation, in a case where multiple cells are aggregated, a UE 102 may assume the same TDD UL/DL configuration across all the cells and that the guard period (GP) of the special subframe(s) in the different cells has an overlap of at least 1456·Tₛ.

Enhanced interference mitigation with traffic adaptation (eIMTA) may enable more flexible use of spectrum using dynamic TDD UL/DL allocation. Therefore, some subframes may be flexible subframes and can be used as either a downlink subframe, an uplink subframe or a special subframe. Some subframes may not be flexible or convertible (e.g., fixed subframes). From the DL HARQ-ACK timing point of view, a special subframe is viewed as a DL subframe. One or more of the subframes 423 illustrated in FIG. 4 may be convertible, depending on the TDD UL/DL reconfiguration range. Assuming a default TDD UL/DL configuration 1 as given in Table (1) above, for example, subframe three (e.g., 3) 423d may be a convertible subframe 433 (from UL-to-DL, for instance).

In some implementations, multiple cells with different TDD UL/DL configurations may be aggregated and the UE 102 may not be capable of simultaneous reception and transmission in the aggregated cells. If the subframe in the primary cell is a downlink subframe, then the UE 102 may not transmit any signal or channel on a secondary cell in the same subframe. If the subframe in the primary cell is an uplink subframe, then the UE 102 may not be expected to receive any downlink transmissions on a secondary cell in the same subframe. If the subframe in the primary cell is a special subframe and the same subframe in a secondary cell is a downlink subframe, then the UE 102 may not be expected to receive PDSCH, enhanced physical downlink control channel (EPDCCH), physical multicast channel (PMCH), and/or PRS transmissions in the secondary cell in the same subframe. Furthermore, if the subframe in the primary cell is a special subframe and the same subframe in a secondary cell is a downlink subframe, the UE 102 may not be expected to receive any other signals on the secondary cell in orthogonal frequency division multiplexed (OFDM) symbols that overlap with the guard period or UpPTS in the primary cell.

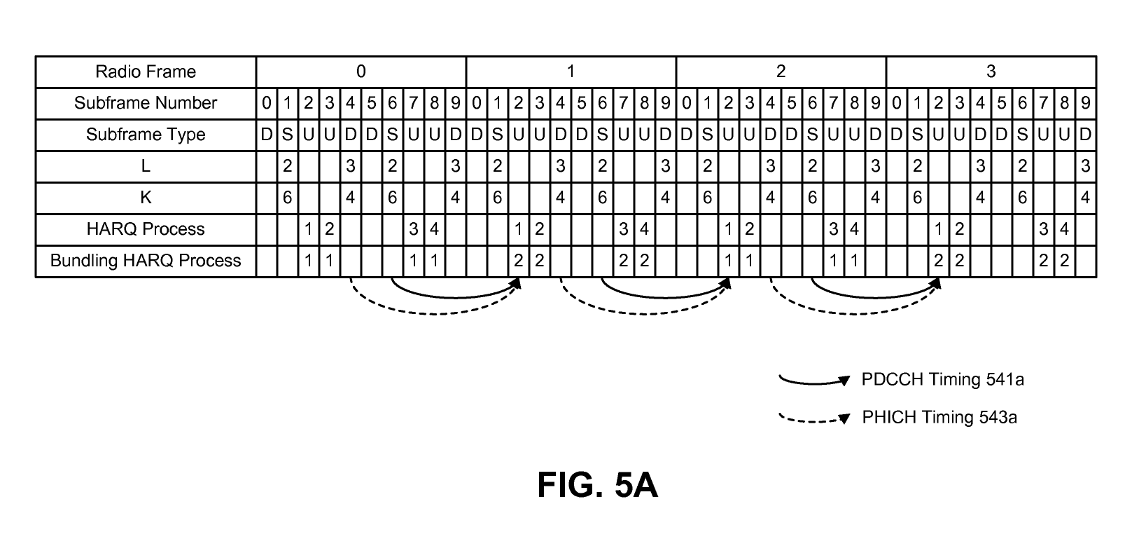

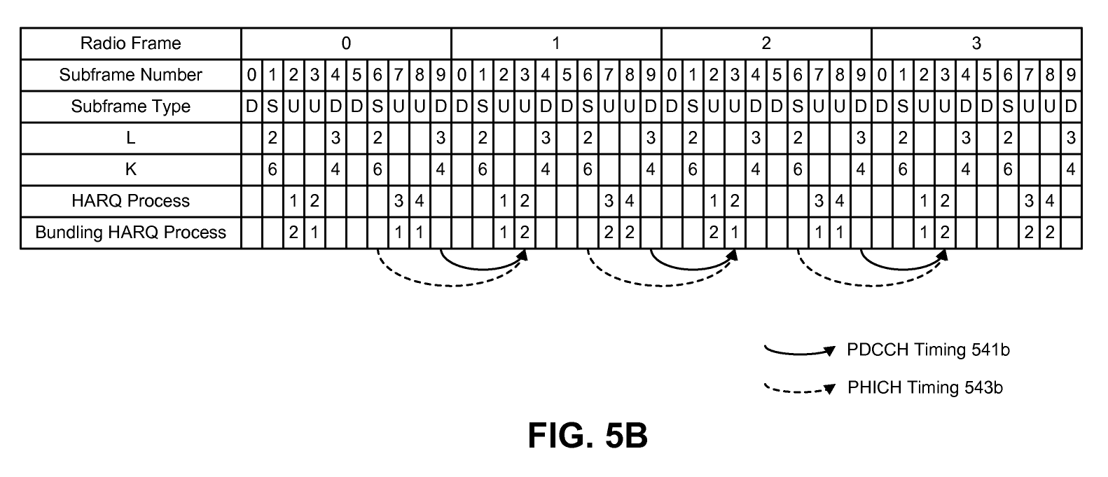

FIGS. 5A and 5B illustrate options for subframe bundling. In FIG. 5A, the PDCCH timing 541a and PHICH timing 543a are shown for a first subframe bundling option for TDD UL/DL configuration 1. The subframes for four radio frames are illustrated.

In some implementations, subframe bundling operation may be configured by a parameter (e.g., ttiBundling) provided by higher layers. In the case where higher layers configure the use of subframe bundling for FDD and TDD, the subframe bundling operation may be applied to an uplink shared channel (UL-SCH), such that consecutive UL subframes may be used for subframe bundling. In one implementation, four consecutive UL subframes may be used for subframe bundling.

In one TDD scenario, a UE 102 may be configured with more than one serving cell. If the TDD UL/DL configurations of at least two serving cells are different, and if the serving cell is a primary cell or if the UE 102 is not configured to monitor PDCCH or EPDCCH in another serving cell for scheduling the serving cell, then the serving cell TDD UL/DL configuration is the UL-reference UL/DL configuration.

In another TDD scenario, if a UE 102 is configured with more than one serving cell, and if a serving cell is a secondary cell (SCell) and at least two serving cells have different TDD UL/DL configurations, and if the UE 102 is configured to monitor PDCCH or EPDCCH in another serving cell to schedule the serving cell, then the UL-reference UL/DL configuration may be decided by the combination of the other serving cell and the serving cell TDD UL/DL configurations. In one TDD CA implementation, the UL-reference UL/DL configuration of the serving cell is defined by Table (3) (from Table 8-0A of 3GPP TS 36.213) based on the pair formed by the other serving cell TDD UL/DL configuration and the serving cell TDD UL/DL configuration. Table (3) may be used as a lookup table to determine a UL-reference UL/DL configuration.

TABLE (3)

| | (Other serving cell TDD UL/DL | UL-reference |
|---|---|---|
| | configuration, Serving cell TDD UL/DL | UL/DL |
| Set # | configuration) | configuration |
| Set 1 | (1, 1), (1, 2), (1, 4), (1, 5) | 1 |
| | (2, 2), (2, 5) | 2 |
| | (3, 3), (3, 4), (3, 5) | 3 |
| | (4, 4), (4, 5) | 4 |
| | (5, 5) | 5 |
| Set 2 | (1, 0), (2, 0), (3, 0), (4, 0), (5, 0) | 0 |
| | (2, 1), (4, 1), (5, 1) | 1 |
| | (5, 2) | 2 |
| | (4, 3), (5, 3) | 3 |
| | (5, 4) | 4 |
| | (1, 6), (2, 6), (3, 6), (4, 6), (5, 6) | 6 |
| Set 3 | (3, 1) | 1 |
| | (3, 2), (4, 2) | 2 |
| | (1, 3), (2, 3) | 3 |
| | (2, 4) | 4 |
| Set 4 | (0, 0), (6, 0) | 0 |
| | (0, 1), (0, 2), (0, 4), (0, 5), (6, 1), (6, 2), (6, 5) | 1 |
| | (0, 3), (6, 3) | 3 |
| | (6, 4) | 4 |
| | (0, 6), (6, 6) | 6 |

For TDD and transmission mode 1, the number of HARQ processes per serving cell may be determined by the TDD UL/DL configuration, as indicated in Table (4) (from Table 8-1 of 3GPP TS 36.213). For TDD and transmission mode 2, the number of HARQ processes per serving cell for non-subframe bundling operation may be twice the number determined by the TDD UL/DL configuration, as indicated in Table (4), and there may be two HARQ processes associated with a given subframe.

TABLE (4)

| | Number of HARQ | Number of HARQ |
|---|---|---|
| TDD UL/DL | processes for non-subframe | processes for subframe |
| configuration | bundling operation | bundling operation |
| 0 | 7 | 3 |
| 1 | 4 | 2 |
| 2 | 2 | N/A |
| 3 | 3 | N/A |
| 4 | 2 | N/A |
| 5 | 1 | N/A |
| 6 | 6 | 3 |

In another TDD scenario, a UE 102 may be configured with one serving cell, or the UE 102 may be configured with more than one serving cell and the TDD UL/DL configuration of all the configured serving cells is the same. In this scenario, for TDD UL/DL configurations 1-6 and non-subframe bundling HARQ operation, the UE 102 may, upon detection of a PDCCH or EPDCCH with uplink DCI format and/or a PHICH transmission in subframe n intended for the UE 102, adjust the corresponding PUSCH transmission in subframe n+k, with k given in Table (5) (from Table 8-2 of 3GPP TS 36.213), according to the PDCCH, EPDCCH and/or PHICH information.

TABLE (5)

| TDD UL/DL | subframe number n | | | | | | | | | |
|---|---|---|---|---|---|---|---|---|---|---|
| Configuration | 0 | 1 | 2 | 3 | 4 | 5 | 6 | 7 | 8 | 9 |
| 0 | 4 | 6 | | | | 4 | 6 | | | |
| 1 | | 6 | | | 4 | | 6 | | | 4 |
| 2 | | | | 4 | | | | | 4 | |
| 3 | 4 | | | | | | | | 4 | 4 |
| 4 | | | | | | | | | 4 | 4 |
| 5 | | | | | | | | | 4 | |
| 6 | 7 | 7 | | | | 7 | 7 | | | 5 |

In this scenario, for TDD UL/DL configuration 0 and non-subframe bundling HARQ operation the UE 102 may, upon detection of a PDCCH or EPDCCH with uplink DCI format and/or a PHICH transmission in subframe n intended for the UE 102, adjust the corresponding PUSCH transmission in subframe n+k if the most significant bit (MSB) of the UL index in the PDCCH or EPDCCH with uplink DCI format is set to 1 or PHICH is received in subframe zero (e.g., n=0) or subframe five (e.g., n=5) in the resource corresponding to I_{PHICH}=0, with k given in Table (5). If the least significant bit (LSB) of the UL index in the DCI format 0/4 is set to 1 in subframe n or a PHICH is received in subframe zero (e.g., n=0) or subframe five (e.g., n=5) in the resource corresponding to I_{PHICH}=1 or PHICH is received in subframe one (e.g., n=1) or subframe six (e.g., n=6), the UE 102 may adjust the corresponding PUSCH transmission in subframe n+7. Furthermore, for TDD UL/DL configuration 0, if both the MSB and LSB of the UL index in the PDCCH or EPDCCH with uplink DCI format are set in subframe n, the UE 102 may adjust the corresponding PUSCH transmission in both subframes n+k and n+7, with k given in Table (5).

In yet another TDD scenario, a UE 102 may be configured with more than one serving cell and the TDD UL/DL configuration of at least two configured serving cells is not the same. In this scenario, for a serving cell with a UL-reference UL/DL configuration belonging to TDD UL/DL configuration 1, 2, 3, 4, 5 or 6 and non-subframe bundling HARQ operation, the UE 102 may, upon detection of a PDCCH or EPDCCH with uplink DCI format and/or a PHICH transmission in subframe n intended for the UE 102, adjust the corresponding PUSCH transmission in subframe n+k for the serving cell, with k given in Table (5), according to the PDCCH, EPDCCH and/or PHICH information, where the “TDD UL/DL Configuration” given in Table (5) refers to the UL-reference UL/DL configuration.

For a serving cell with a UL-reference UL/DL configuration belonging to TDD UL/DL configuration 0 and non-subframe bundling HARQ operation, the UE 102 may, upon detection of a PDCCH or EPDCCH with uplink DCI format and/or a PHICH transmission in subframe n intended for the UE 102, adjust the corresponding PUSCH transmission in subframe n+k for the serving cell if the MSB of the UL index in the PDCCH or EPDCCH with uplink DCI format is set to 1, or PHICH is received in subframe n=0 or 5 in the resource corresponding to I_{PHICH}=0, with k given in Table (5). If, the LSB of the UL index in the DCI format 0/4 is set to 1 in subframe n or a PHICH is received in subframe zero (e.g., n=0) or subframe five (e.g., n=5) in the resource corresponding to I_{PHICH}=1, or PHICH is received in subframe one (e.g., n=1) or subframe six (e.g., n=1), the UE 102 may adjust the corresponding PUSCH transmission in subframe n+7 for the serving cell. If both the MSB and LSB of the UL index in the PDCCH or EPDCCH with uplink DCI format are set in subframe n, the UE 102 may adjust the corresponding PUSCH transmission in both subframes n+k and n+7 for the serving cell, with k given in Table (5), where the “TDD UL/DL Configuration” given in Table (5) refers to the UL-reference UL/DL configuration.

In some implementations, a serving cell configured with subframe bundling may utilize TDD UL/DL configuration 1 or 6. In this case, a UE 102 may, upon detection of a PDCCH or EPDCCH with DCI format 0 in subframe n intended for the UE 102, and/or a PHICH transmission intended for the UE 102 in subframe n−l with l given in Table (6) (from Table 8-2a of 3GPP TS 36.213), adjust the corresponding first PUSCH transmission in the bundle in subframe n+k, with k given in Table (5), according to the PDCCH, EPDCCH and/or PHICH information.

TABLE (6)

| TDD UL/DL | subframe number n | | | | | | | | | |
|---|---|---|---|---|---|---|---|---|---|---|
| Configuration | 0 | 1 | 2 | 3 | 4 | 5 | 6 | 7 | 8 | 9 |
| 0 | 9 | 6 | | | | 9 | 6 | | | |
| 1 | | 2 | | | 3 | | 2 | | | 3 |
| 6 | 5 | 5 | | | | 6 | 6 | | | 8 |

In another implementation, a serving cell configured with subframe bundling may utilize TDD UL/DL configuration 0. In this case, a UE 102 may, upon detection of a PDCCH or EPDCCH with DCI format 0 in subframe n intended for the UE 102, and/or a PHICH transmission intended for the UE 102 in subframe n−l with l given in Table (6), adjust the corresponding first PUSCH transmission in the bundle in subframe n+k, if the MSB of the UL index in the DCI format 0 is set to 1 or if I_{PHICH}=0, with k given in Table (5), according to the PDCCH, EPDCCH and/or PHICH information. If the LSB of the UL index in the PDCCH or EPDCCH with DCI format 0 is set to 1 in subframe n or if I_{PHICH}=1, the UE 102 may adjust the corresponding first PUSCH transmission in the bundle in subframe n+7, according to the PDCCH, EPDCCH and/or PHICH information.

Different PHICH assignment procedures may be employed based on FDD or TDD operation. In some implementations, a UE 102 may not be configured with multiple timing advance unit groups (TAGs), or the UE 102 may be configured with multiple TAGs, but PUSCH transmissions scheduled from serving cell c in subframe n are not scheduled by a random access response grant corresponding to a random access preamble transmission for a secondary cell. In an FDD scenario, for PUSCH transmissions scheduled from serving cell c in subframe n, the UE 102 may determine the corresponding PHICH resource of serving cell c in subframe n+k_{PHICH}, where k_{PHICH} may be 4.

For a TDD scenario, if the UE 102 is configured with one serving cell, or if the UE 102 is configured with more than one serving cell and the TDD UL/DL configuration of all the configured serving cells is the same, for PUSCH transmissions scheduled from serving cell c in subframe n, the UE 102 may determine the corresponding PHICH resource of serving cell c in subframe n+k_{PHICH}, where k_{PHICH} is given in Table (7) (from Table 9.1.2-1 of 3GPP TS 36.213). In another TDD scenario, if the UE 102 is configured with more than one serving cell and the TDD UL/DL configuration of at least two configured serving cells is not the same, for PUSCH transmissions scheduled from serving cell c in subframe n, the UE 102 may determine the corresponding PHICH resource of serving cell c in subframe n+k_{PHICH}, where k_{PHICH} is given in Table (7), where the “TDD UL/DL Configuration” refers to the UL-reference UL/DL configuration of the serving cell corresponding to the PUSCH transmission.

TABLE (7)

| TDD UL/DL | subframe index n | | | | | | | | | |
|---|---|---|---|---|---|---|---|---|---|---|
| Configuration | 0 | 1 | 2 | 3 | 4 | 5 | 6 | 7 | 8 | 9 |
| 0 | | | 4 | 7 | 6 | | | 4 | 7 | 6 |
| 1 | | | 4 | 6 | | | | 4 | 6 | |
| 2 | | | 6 | | | | | 6 | | |
| 3 | | | 6 | 6 | 6 | | | | | |
| 4 | | | 6 | 6 | | | | | | |
| 5 | | | 6 | | | | | | | |
| 6 | | | 4 | 6 | 6 | | | 4 | 7 | |

For subframe bundling operation, the corresponding PHICH resource may be associated with the last subframe in the bundle.

In order to transmit on the UL-SCH, the UE 102 may receive a valid uplink grant (except for non-adaptive HARQ retransmissions). In one implementation, the UE 102 may receive a UL grant dynamically on the PDCCH or in a random access response. In another implementation, the UL grant may be configured semi-persistently. To perform requested transmissions, the MAC layer may receive HARQ information from lower layers. When the physical layer is configured for uplink spatial multiplexing, the MAC layer may receive up to two grants (one per HARQ process) for the same TTI from lower layers.

The UE 102 may include one HARQ entity for each serving cell with a configured uplink. The HARQ entity may maintain a number of parallel HARQ processes allowing for transmissions to take place continuously while waiting for the HARQ feedback on the successful or unsuccessful reception of previous transmissions. In one implementation, when the physical layer is configured for uplink spatial multiplexing, there may be two HARQ processes associated with a given TTI. Otherwise there may be one HARQ process associated with a given TTI.

At a given TTI, if an uplink grant is indicated for the TTI, the HARQ entity may identify the HARQ process(es) for which a transmission should take place. The HARQ entity may also route the received HARQ feedback (ACK/NACK information), modulation and coding scheme (MCS) and resource, relayed by the physical layer, to the appropriate HARQ process(es).

When subframe bundling (e.g., TTI bundling) is configured, the parameter TTI_BUNDLE_SIZE may provide the number of subframes (e.g., TTIs) of a bundle (e.g., TTI bundle). Subframe bundling operation may rely on the HARQ entity for invoking the same HARQ process for each transmission that is part of the same bundle. Within a bundle, HARQ retransmissions may be non-adaptive and may be triggered without waiting for feedback from previous transmissions according to TTI_BUNDLE_SIZE. The HARQ feedback of a bundle may be received for the last subframe of the bundle (e.g., the subframe corresponding to TTI_BUNDLE_SIZE), regardless of whether a transmission in that subframe takes place or not (e.g., when a measurement gap occurs). A retransmission of a bundle may also be a bundle. Subframe bundling may not be supported when the UE 102 is configured with one or more secondary cells (SCells) with configured uplink.

Each HARQ process may be associated with a HARQ buffer. In one implementation, each HARQ process may maintain a state variable CURRENT_TX_NB, which indicates the number of transmissions that have taken place for the MAC protocol data unit (PDU) currently in the buffer, and a state variable HARQ_FEEDBACK, which indicates the HARQ feedback for the MAC PDU currently in the buffer. When the HARQ process is established, CURRENT_TX_NB may be initialized to 0.

The sequence of redundancy versions may be 0, 2, 3, 1. In one implementation, the variable CURRENT_IRV is an index into the sequence of redundancy versions. The variable CURRENT_IRV may be up-dated modulo 4.

New transmissions may be performed on the resource and with the MCS indicated on PDCCH or random access response. Adaptive retransmissions may be performed on the resource and, if provided, with the MCS indicated on PDCCH. Non-adaptive retransmission may be performed on the same resource and with the same MCS as was used for the last made transmission attempt.

Different options for subframe bundling in TDD UL/DL configuration 1 are illustrated in FIGS. 5A and 5B. Multiple options may be utilized depending on when a UL grant for an initial transmission is transmitted. A bundling HARQ process (e.g., a HARQ process in a subframe bundling operation) may be aligned with the same set of HARQ processes for non-subframe bundling HARQ operation.

In a first option shown in FIG. 5A, a UL grant for bundling HARQ process #2 is provided in subframe (0, 6), where the index values correspond to (Frame Number, Subframe Number). Because k for subframe 6 for TDD UL/DL configuration 1 is 6 (as indicated by Table (5)), the initial transmission is allocated in subframe (1, 2). The four consecutive UL subframes are (1, 2), (1, 3), (1, 7), (1, 8). For subframe bundling operation, the corresponding PHICH resource is associated with the last subframe in the bundle. Therefore, the PHICH for bundling HARQ process #2 is provided in subframe (2, 4) because k_{PHICH}=6 for subframe 8 for TDD UL/DL configuration 1 (as indicated by Table (7)).

To ensure that the HARQ process numbers of non-subframe bundling HARQ operation for the first transmission of the initial transmission of a bundle and the first transmission of retransmission of the bundle are the same (in this case 1, 2, 3, 4 for non-subframe bundling HARQ operation are mapped to bundling HARQ process #2 for subframe bundling), the next first subframe for the bundle is subframe (3, 2). Because k=6 for subframe 6, the UL grant for (3, 2) is provided in (2, 6). If the UE 102 did not receive a UL grant, the UE 102 may follow the PHICH for non-adaptive retransmission. If the UE 102 receives the UL grant indicating HARQ retransmission, the UE 102 may follow UL grant for adaptive retransmission. Because 1=2 for subframe 6 of TDD UL/DL configuration 1 (as indicated by Table (6)), the PHICH in (2, 4) indicates a HARQ non-adaptive retransmission in (3, 2).

A second option for subframe bundling in TDD UL/DL configuration 1 is shown in FIG. 5B. The PDCCH timing 541b and PHICH timing 543b are shown for four radio frames. A UL grant for bundling HARQ process #2 is provided in subframe (0, 9). Because k=4 for subframe 9 for TDD UL/DL configuration 1 (as indicated by Table (5)), the initial transmission is allocated in (1, 3). The four consecutive UL subframes are (1, 3), (1, 7), (1, 8), (2, 2). The corresponding PHICH resource for bundling HARQ process #2 (associated with the last subframe in the bundle) is provided in (2, 6) because k_{PHICH}=4 for subframe 2 for TDD UL/DL configuration 1 (as indicated by Table (7)).

To ensure that the HARQ process numbers of non-subframe bundling HARQ operation for the first transmission of the initial transmission of a bundle and the first transmission of retransmission of the bundle are the same (in this case 2, 3, 4, 1 for non-subframe bundling HARQ operation are mapped to bundling HARQ process #2 for subframe bundling), the next first subframe for the bundle is (3, 3). Because k=4 for subframe 9, the UL grant for subframe (3, 3) is provided in subframe (2, 9). If the UE 102 did not receive the UL grant, the UE 102 may follow the PHICH for non-adaptive retransmission. If the UE 102 receives the UL grant indicating HARQ retransmission, the UE 102 may follow the UL grant for adaptive retransmission. Because l=3 for subframe 9 for TDD UL/DL configuration 1, the PHICH in subframe (2, 6) indicates a HARQ non-adaptive retransmission in subframe (3, 3).

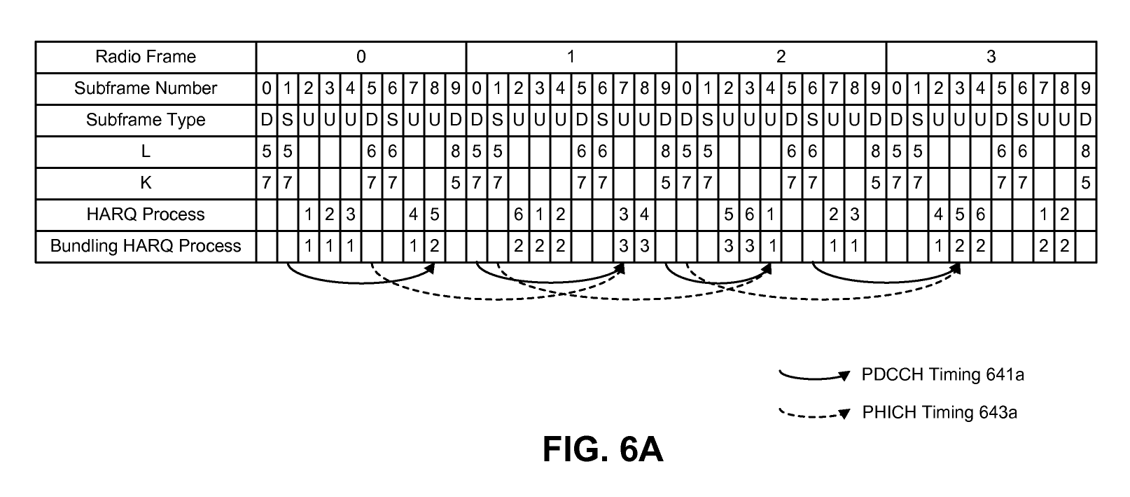

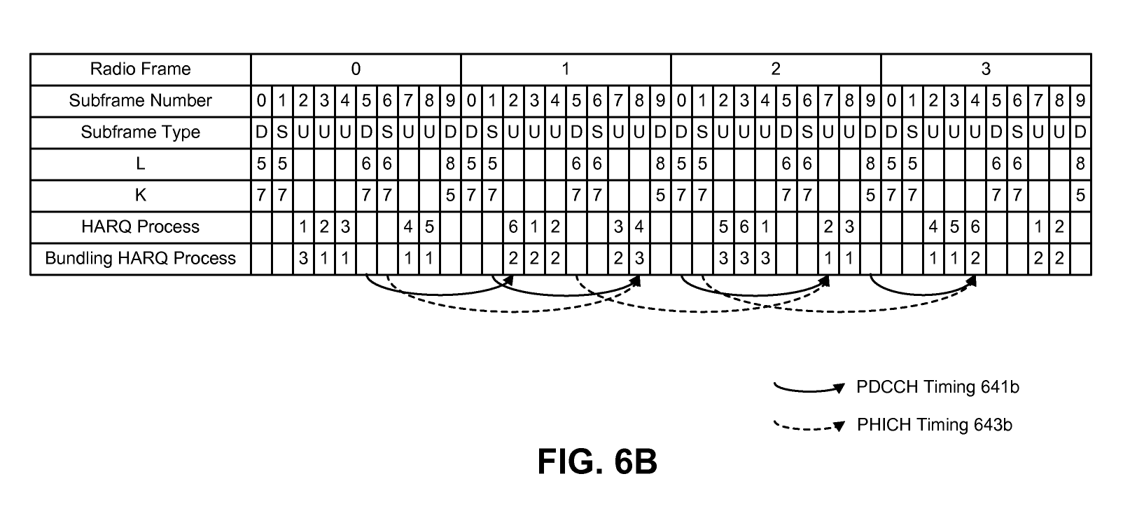

FIGS. 6A and 6B illustrate more options for subframe bundling. In FIG. 6A, the PDCCH timing 641a and PHICH timing 643a for four radio frames are illustrated. There are multiple options for subframe bundling depending on when a UL grant for initial transmission is transmitted. A first option for subframe bundling in TDD UL/DL configuration 6 is shown in FIG. 6A. A UL grant for bundling HARQ process #2 is provided in subframe (0, 1). Because k=7 for subframe 1 in TDD UL/DL configuration 6 (as indicated by Table (5)), the initial transmission is allocated in subframe (0, 8). The four consecutive UL subframes are (0, 8), (1, 2), (1, 3), (1, 4). The corresponding PHICH resource for bundling HARQ process #2 (associated with the last subframe in the bundle) is provided in (2, 0) because k_{PHICH}=6 for subframe 4 for TDD UL/DL configuration 6 (as indicated by Table (7)).

A HARQ process in a subframe bundling operation may be aligned with the same set of HARQ processes in non-subframe bundling HARQ operation. In this case, HARQ processes 5, 6, 1, 2 for non-subframe bundling HARQ operation are mapped to bundling HARQ process #2 for subframe bundling. Furthermore, to ensure that the HARQ process numbers of non-subframe bundling HARQ operation for the first transmission of the initial transmission of a bundle and the first transmission of retransmission of the bundle are the same, the next first subframe for the bundle is subframe (3, 3). Because k=7 for subframe 6, the UL grant for subframe (3, 3) is provided in subframe (2, 6). If the UE 102 did not receive the UL grant, the UE 102 may follow the PHICH for non-adaptive retransmission. If the UE 102 receives the UL grant indicating HARQ retransmission, the UE 102 may follow the UL grant for adaptive retransmission. Because l=6 for subframe 6 for TDD UL/DL configuration 6, the PHICH in subframe (2, 0) indicates HARQ non-adaptive retransmission in subframe (3, 3).

A second option for subframe bundling in TDD UL/DL configuration 6 is shown in FIG. 6B. The PDCCH timing 641b and PHICH timing 643b are shown for four radio frames. Three bundling HARQ processes are illustrated. A UL grant for a second bundling HARQ process is provided in subframe (0, 5). HARQ processes 6, 1, 2, 3 for non-subframe bundling HARQ operation are mapped to bundling HARQ process #2 for subframe bundling. The remaining PDCCH timing 641b and PHICH timing 643b may be determined as described above.

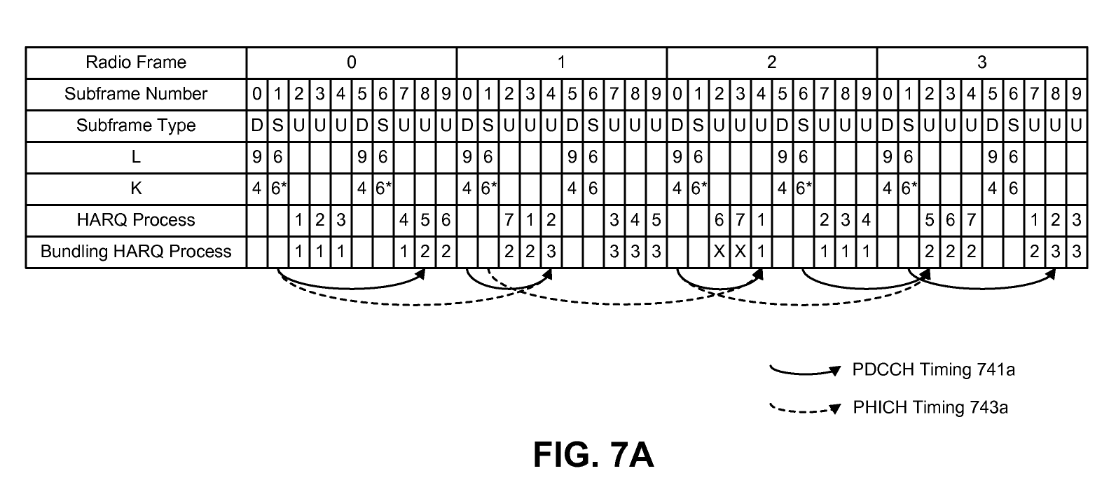

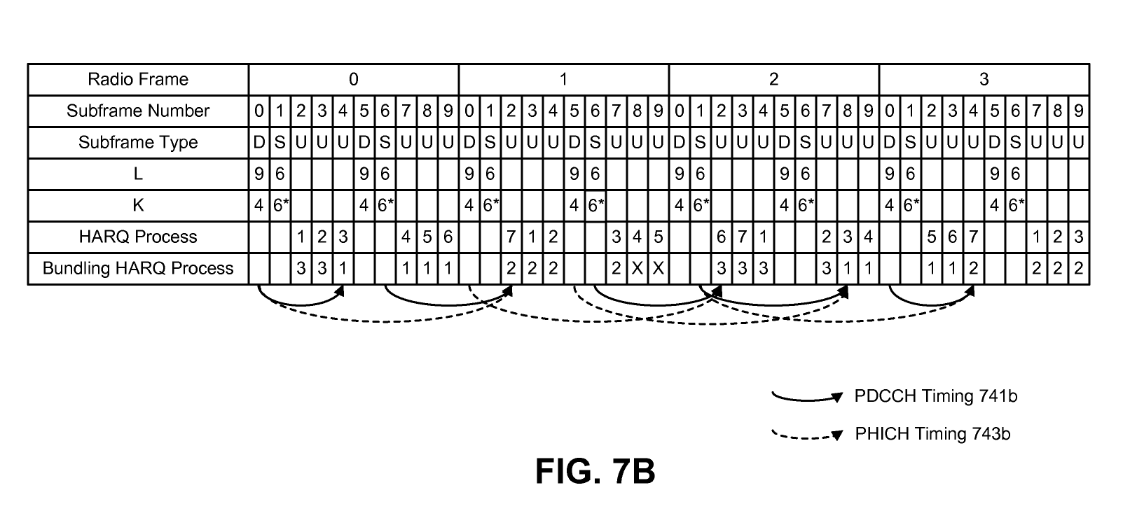

FIGS. 7A and 7B illustrate yet more options for subframe bundling. In FIG. 7A, the PDCCH timing 741a and PHICH timing 743a for four radio frames are illustrated. In a first option for subframe bundling in TDD UL/DL configuration 0, a UL grant for bundling HARQ process #2 is provided in subframe (0, 1). It should be noted that for TDD UL/DL configuration 0, if a UL grant with the LSB of the UL index=1 is received in subframe one (e.g., n=1) or subframe six (e.g., n=6), the UE 102 may adjust the corresponding PUSCH transmission in subframe n+7. This is indicated in FIGS. 7A and 7B by the “*” next to the k values corresponding to subframes one and six. Therefore, the initial transmission for bundling HARQ process #2 is allocated in subframe (0, 8). The four consecutive UL subframes are (0, 8), (0, 9), (1, 2), (1, 3). The corresponding PHICH resource for bundling HARQ process #2 (associated with the last subframe in the bundle) is provided in (2, 0) because k_{PHICH}=7 for subframe 3 for TDD UL/DL configuration 0 (as indicated by Table (7)).

A bundling HARQ process in a subframe bundling operation may be aligned with the same set of HARQ processes in non-subframe bundling HARQ operation. In this case, HARQ processes 5, 6, 7, 1 for non-subframe bundling HARQ operation are mapped to bundling HARQ process #2 for subframe bundling. Furthermore, to ensure that the HARQ process numbers of non-subframe bundling HARQ operation for the first transmission of the initial transmission of a bundle and the first transmission of retransmission of the bundle are the same, the next first subframe for the bundle is subframe (3, 2). Because k=6 for subframe 6, the UL grant for subframe (3, 2) is provided in subframe (2, 6). If the UE 102 did not receive the UL grant, the UE 102 may follow the PHICH for non-adaptive retransmission. If the UE 102 receives the UL grant indicating HARQ retransmission, the UE 102 may follow the UL grant for adaptive retransmission. Because l=6 for subframe 6 for TDD UL/DL configuration 0, the PHICH in subframe (2, 0) indicates HARQ non-adaptive retransmission in subframe (3, 2). It should be noted that the “X” values indicate uplink subframes that are not used in this subframe bundling operation.

A second option for subframe bundling in TDD UL/DL configuration 0 is shown in FIG. 7B. The PDCCH timing 741b and PHICH timing 743b are shown for four radio frames. Three bundling HARQ processes are illustrated. A UL grant for a bundling HARQ process #2 is provided in subframe (0, 0). HARQ processes 7, 1, 2, 3 for non-subframe bundling HARQ operation are mapped to bundling HARQ process #2 for subframe bundling. The remaining PDCCH timing 741b and PHICH timing 743b may be determined as described above.

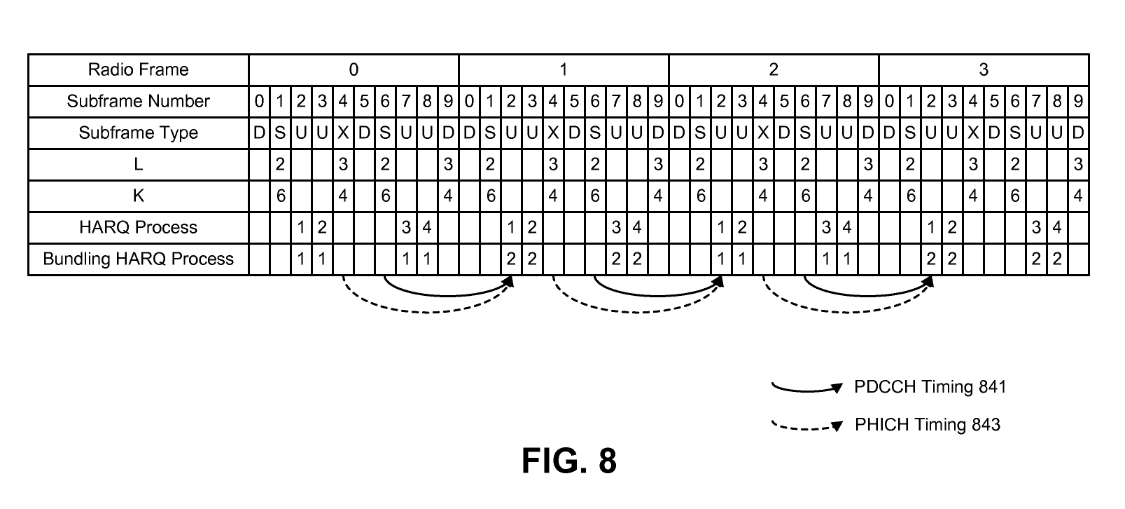

FIG. 8 illustrates one example of subframe bundling with dynamic subframe type conversion according to a first implementation. The PDCCH timing 841 and PHICH timing 843 are shown for four radio frames. A UE 102 may be configured with a serving cell that supports dynamic subframe type conversion. As used herein, a serving cell that supports “dynamic subframe type conversion” refers to an eIMTA serving cell. For example, the UE 102 may be configured with an eIMTA serving cell in which at least one subframe can be converted to a different subframe type. As used herein, “the UE 102 is configured with a serving cell with dynamic subframe type conversion” may refer to “the UE 102 is configured with a second UL/DL configuration of the serving cell.” In one implementation, “the UE 102 is configured with a serving cell with dynamic subframe type conversion” may refer to “the UE 102 is configured with a DL-reference UL/DL configuration of the serving cell.” In another implementation, “the UE 102 is configured with a serving cell with dynamic subframe type conversion” may refer to “the UE 102 is configured with a UL-reference UL/DL configuration of the serving cell.” In yet another implementation, “the UE 102 is configured with a serving cell with dynamic subframe type conversion” may refer to “the UE 102 is configured with a DL-reference UL/DL configuration of the serving cell and a UL-reference UL/DL configuration of the serving cell”.

A non-PUSCH transmission subframe is a subframe that is not be able to be used for PUSCH transmission. A non-PUSCH transmission subframe may be a downlink subframe or a special subframe that is not able to be used for PUSCH transmission. An uplink transmission subframe is a subframe that is able to be used for PUSCH transmission. An uplink transmission subframe may be an uplink subframe or a special subframe that is able to be used for PUSCH transmission. One special subframe is only used for SRS for uplink transmission (e.g., the special subframe that is not able to be used for PUSCH transmission). Another special subframe is used for SRS and PUSCH for uplink transmission (e.g., the special subframe that is able to be used for PUSCH transmission).

Whether a subframe is an uplink transmission subframe or not may be determined based on signaling. For example, the subframe type may be determined based on the explicitly signaled TDD UL/DL configuration in the PHY layer. In one implementation, if the UE 102 could not receive the PHY layer signaling, the UE 102 may determine the subframe type (e.g., a downlink subframe, an uplink subframe, a special subframe that is not able to be used for PUSCH transmission or a special subframe that is able to be used for PUSCH transmission) based on a predetermined UL/DL configuration. For example, the predetermined UL/DL configuration may be a TDD UL/DL configuration, a DL-reference UL/DL configuration or a UL-reference UL/DL configuration. In another implementation, if the UE 102 could not receive the PHY layer signaling, the UE 102 may determine the subframe type based on a UL grant for the subframe.

In one scenario, a serving cell may be configured with UL-reference UL/DL configuration 1 or 6 and subframe bundling operation. The UE 102 may, upon detection of a PDCCH or EPDCCH with uplink DCI format (e.g. DCI format 0 or 4, UL grant) in subframe n intended for the UE 102, and/or a PHICH transmission intended for the UE 102 in subframe n−l, with l given in Table (6), adjust the corresponding first PUSCH transmission in the bundle in subframe n+k, with k given in Table (5), according to the PDCCH, EPDCCH and/or PHICH information. In this scenario, the “TDD UL/DL Configuration” given in Table (5) refers to the UL-reference UL/DL configuration.

In another scenario, a serving cell may be configured with UL-reference UL/DL configuration 0 and subframe bundling operation. The UE 102 may, upon detection of a PDCCH or EPDCCH with an uplink DCI format in subframe n intended for the UE 102, and/or a PHICH transmission intended for the UE 102 in subframe n−l, with l given in Table (6), adjust the corresponding first PUSCH transmission in the bundle in subframe n+k, if the MSB of the UL index in the DCI format 0 is set to 1 or if I_{PHICH}=0, with k given in Table (5), according to the PDCCH, EPDCCH and/or PHICH information. If, for UL-reference UL/DL configuration 0 and subframe bundling operation, the LSB of the UL index in the PDCCH or EPDCCH with DCI format 0 is set to 1 in subframe n or if I_{PHICH}=1, the UE 102 may adjust the corresponding first PUSCH transmission in the bundle in subframe n+7, according to the PDCCH, EPDCCH and/or PHICH information.

In a first implementation of subframe bundling with dynamic subframe type conversion, a UE 102 may be configured with a serving cell with subframe bundling. The serving cell may be configured with a first UL/DL configuration and a second UL/DL configuration. Consecutive UL subframes for subframe bundling may be determined based on the second UL/DL configuration. A subframe bundling operation may be performed based on the consecutive UL subframes. The consecutive UL subframes may include a number of UL subframes corresponding to a TTI bundle size.

The first UL/DL configuration may be a TDD UL/DL configuration that is signaled in a system information block (e.g., SystemInformationBlockType1) or a radio resource configuration (RRC) message (e.g., RadioResourceConfigCommon or RadioResourceConfigCommonSCell-r10). In one implementation, the second UL/DL configuration may be a UL-reference UL/DL configuration. In another implementation, the second UL/DL configuration may be a DL-reference UL/DL configuration. In yet another implementation, the second UL/DL configuration may be a TDD UL/DL configuration that is used for deriving the UL-reference UL/DL configuration. In another implementation, the second UL/DL configuration may be a TDD UL/DL configuration that is used for deriving the DL-reference UL/DL configuration.

The second UL/DL configuration may be signaled by RRC dedicated signaling. For example, the second UL/DL configuration may be signaled by a radio resource configuration (RRC) message (e.g., RadioResourceConfigDedicated or RadioResourceConfigDedicatedSCell-r10). The second UL/DL configuration may be signaled by RRC common signaling. For example, the second UL/DL configuration may be signaled by a system information block (e.g., SystemInformationBlockType1) or a radio resource configuration (RRC) message (e.g., RadioResourceConfigCommon or RadioResourceConfigCommonSCell-r10) in addition to the first UL/DL configuration.

The second UL/DL configuration may be derived differently depending on whether subframe bundling is configured. For example, in one case, the second UL/DL configuration may be based on a first UL/DL configuration of the serving cell when the UE 102 is configured with subframe bundling. In another case, the second UL/DL configuration may be based on another TDD UL/DL configuration when the UE 102 is not configured with subframe bundling.

In one implementation, the second UL/DL configuration may be derived based on a first UL/DL configuration of the serving cell and/or a UL-reference UL/DL configuration of the serving cell when the UE 102 is configured with subframe bundling. In another implementation, the second UL/DL configuration may be derived based on a first UL/DL configuration of the serving cell and/or a DL-reference UL/DL configuration of the serving cell when the UE 102 is configured with subframe bundling.

The UL-reference UL/DL configuration may be different than a TDD UL/DL configuration of the serving cell. Therefore, an eNB 160 may choose the UL-reference UL/DL configuration for the UE 102 such that all, or most, of the flexible subframes are not included in the UL subframes of the UL-reference UL/DL configuration. Therefore, one or more flexible subframes may be free from (e.g., do not participate in) a subframe bundling operation.

One example of subframe bundling with dynamic subframe type conversion is illustrated in FIG. 8. In this example, a TDD UL/DL configuration (e.g., the first UL/DL configuration) is 6 and a UL-reference UL/DL configuration (e.g., the second UL/DL configuration) is 1. The fourth subframe of each radio frame is a flexible subframe. Because the DL-reference UL/DL configuration is 1, the fourth subframe may convert from a UL subframe to a DL subframe. Furthermore, because the fourth subframe is not a UL subframe of the UL-reference UL/DL configuration, a PUSCH transmission in the fourth subframe may not occur. The fourth subframe is not included in a bundle of four consecutive UL subframes. It should be noted that although the first UL/DL configuration is 6 in this example, the consecutive UL subframes are determined based on UL-reference UL/DL configuration 1. Therefore, the PDCCH timing 841 and PHICH timing 843 for subframe bundling may be determined as described above in connection with FIGS. 5A and 5B.

In one implementation, an eNB 160 may select the UL-reference UL/DL configuration. The eNB 160 may ensure that the UE 102 sets the UL-reference UL/DL configuration by using RRC dedicated signaling when the UE 102 is configured with a serving cell with subframe bundling. For the eNB 160 to ensure that the UE 102 sets the UL-reference UL/DL configuration, the eNB 160 may signal the UL-reference UL/DL configuration. For example, the eNB 160 may signal the UL-reference UL/DL configuration 1 to the UE 102. In another example, the eNB 160 may signal a second UL/DL configuration 1 and the UE 102 may determine (or derive) the UL-reference UL/DL configuration 1 based on the pair of the first UL/DL configuration 6 and the second UL/DL configuration 1.

In another implementation, the second UL/DL configuration may be derived differently depending on whether subframe bundling is configured. For example, if the UE 102 is configured with a serving cell with subframe bundling, the UE 102 may determine (or derive) UL-reference UL/DL configuration 1 based on the pair of TDD UL/DL configuration 6 and the DL-reference UL/DL configuration 1. However, if the UE 102 is configured with a serving cell without subframe bundling, the UE 102 may determine or derive UL-reference UL/DL configuration 6 based on the first UL/DL configuration and/or the second UL/DL configuration.

In an alternative of the first implementation of subframe bundling with dynamic subframe type conversion, if the UE 102 is configured with a serving cell with subframe bundling, the consecutive UL subframes for subframe bundling may be determined based on the UL subframes of a first UL/DL configuration of the serving cell even if a second UL/DL configuration is configured. In other words, consecutive UL subframes for subframe bundling may be determined based on the UL subframes of a first UL/DL configuration even if the UE 102 has or sets a UL-reference UL/DL configuration of the serving cell.

The second UL/DL configuration may be signaled by RRC dedicated signaling in addition to the signaling for the first UL/DL configuration. The first UL/DL configuration may be signaled in a system information block (e.g., SystemInformationBlockType1) or a radio resource configuration (RRC) message (e.g., RadioResourceConfigCommon or RadioResourceConfigCommonSCell-r10). By this alternative of the first implementation of subframe bundling with dynamic subframe type conversion, the HARQ process(es) and timing of the subframe bundling operation may be compatible with legacy UEs 102.

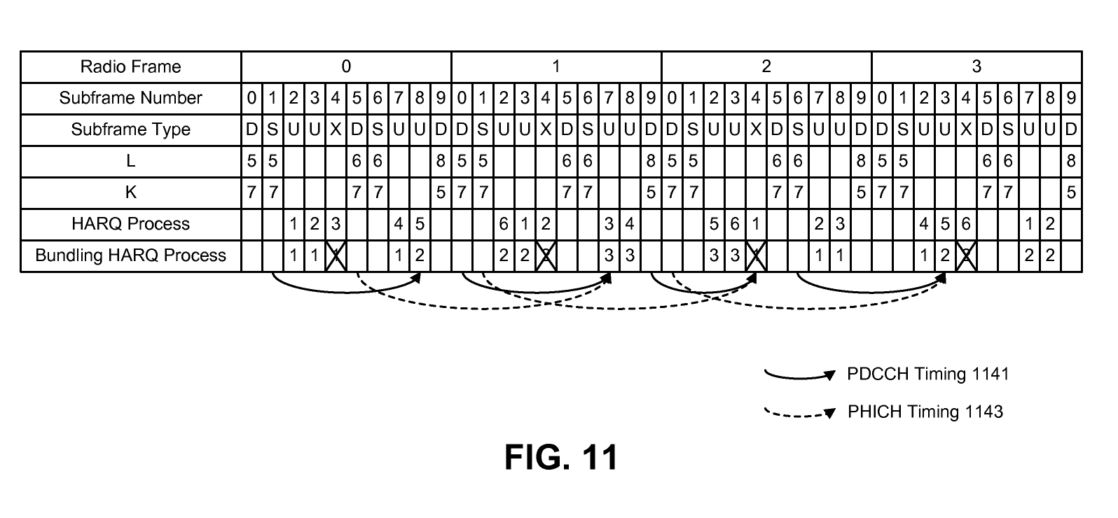

This first implementation may be combined with a second implementation described below in connection with FIG. 11. For example, the UE 102 may drop a PUSCH transmission in a subframe in a bundle if the subframe is determined to be a non-PUSCH transmission subframe. Furthermore, the eNB 160 may assume that a PUSCH transmission in a subframe in a bundle may be dropped if the subframe is determined as a non-PUSCH transmission subframe. The eNB 160 may choose any UL-reference UL/DL configuration for the UE 102.

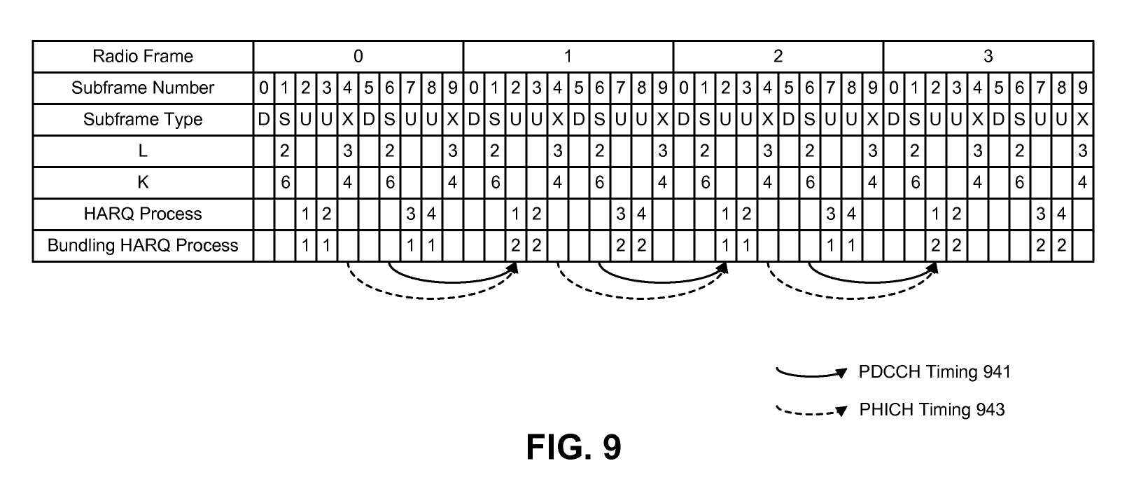

FIG. 9 illustrates another example of subframe bundling with dynamic subframe type conversion according to a first implementation. The PDCCH timing 941 and PHICH timing 943 are shown for four radio frames. The first implementation is described above in connection with FIG. 8. In this example, a TDD UL/DL configuration (e.g., the first UL/DL configuration) is 0 and a UL-reference UL/DL configuration (e.g., the second UL/DL configuration) is 1. Because the DL-reference UL/DL configuration is 1, the fourth subframe and the ninth subframe are flexible subframes. Therefore, the fourth subframe or the ninth subframe may convert from a UL subframe to a DL subframe. Because the fourth subframe or the ninth subframe are not UL subframes of the UL-reference UL/DL configuration, a PUSCH transmission in the fourth subframe or the ninth subframe may not occur. In this example, the fourth subframe and the ninth subframe are not included in a bundle of four consecutive UL subframes.

It should be noted that although the first UL/DL configuration is 0 in this example, the consecutive UL subframes are determined based on UL-reference UL/DL configuration 1. Therefore, the PDCCH timing 941 and PHICH timing 943 for subframe bundling may be determined as described above in connection with FIGS. 5A and 5B.

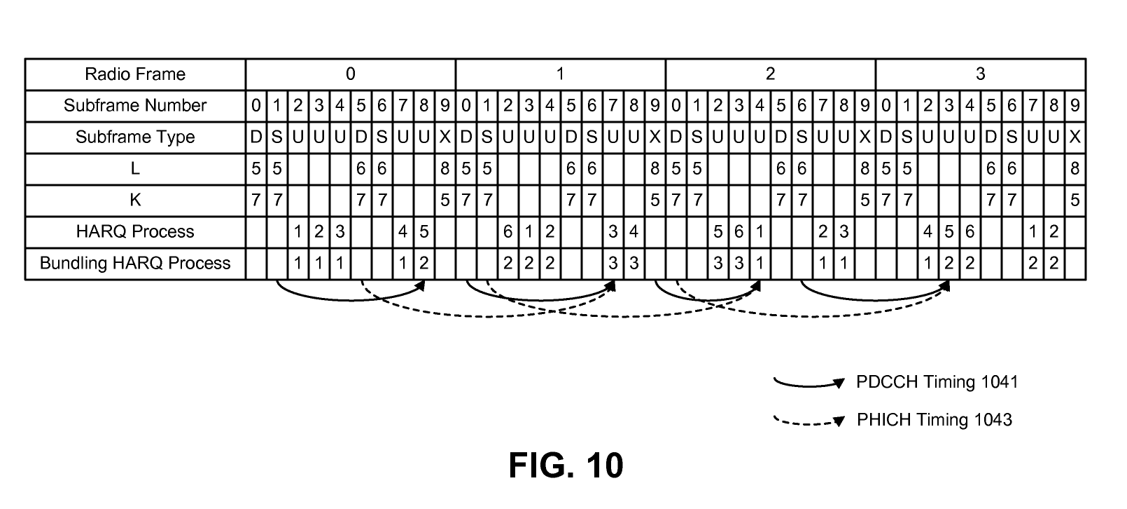

FIG. 10 illustrates yet another example of subframe bundling with dynamic subframe type conversion according to a first implementation. The PDCCH timing 1041 and PHICH timing 1043 are shown for four radio frames. The first implementation is described above in connection with FIG. 8. In this example, a TDD UL/DL configuration (e.g., the first UL/DL configuration) is 0 and a UL-reference configuration (e.g., the second UL/DL configuration) is 6. Because DL-reference UL/DL configuration is 6, the ninth subframe is a flexible subframe. Therefore, the ninth subframe may convert from UL subframe to DL subframe. Because the ninth subframe is not UL subframe of the UL-reference configuration, a PUSCH transmission in the ninth subframe may not occur. In this example, the ninth subframe is not included in a bundle of 4 consecutive UL subframes.

It should be noted that although the first UL/DL configuration is 0 in this example, the consecutive UL subframes are determined based on UL-reference UL/DL configuration 6. Therefore, the PDCCH timing 1041 and PHICH timing 1043 for subframe bundling may be determined as described above in connection with FIGS. 6A and 6B.

FIG. 11 illustrates one example of subframe bundling with dynamic subframe type conversion according to a second implementation. The PDCCH timing 1141 and PHICH timing 1143 are shown for four radio frames. A UE 102 may be configured with a serving cell that supports dynamic subframe type conversion and subframe bundling. The UE 102 may be configured with a second UL/DL configuration of the serving cell. In one implementation, the UE 102 may be configured with a DL-reference UL/DL configuration of the serving cell. In another implementation, the UE 102 may be configured with a UL-reference UL/DL configuration of the serving cell.

The UE 102 may drop a PUSCH transmission in a subframe in a bundle if the subframe is determined as a non-PUSCH transmission subframe. Furthermore, an eNB 160 may assume that a PUSCH transmission in a subframe in a bundle is dropped if the subframe is determined as a non-PUSCH transmission subframe.

In some circumstances, the MAC layer of the UE 102 may not know that the PUSCH transmission is dropped in a non-PUSCH transmission subframe. Therefore, in one case, the MAC layer of the UE 102 may instruct the PHY layer of the UE 102 to generate a transmission according to the stored UL grant, but the PHY layer may drop PUSCH transmission if the subframe is determined as a non-PUSCH transmission subframe. In this case, the redundancy version of HARQ retransmission and the number of the current transmission may be incremented in the MAC layer.

In another case, the MAC layer of the UE 102 may know that a subframe is a non-PUSCH transmission subframe based on information from the PHY layer of the UE 102. The MAC layer may not instruct PHY layer of the UE 102 to generate a transmission according to the stored UL grant if the subframe is determined as a non-PUSCH transmission subframe. In this case, the redundancy version of the HARQ retransmission and the number of the current transmission may not be incremented in the MAC layer.

In yet another case, the MAC layer of the UE 102 may know that a subframe is a non-PUSCH transmission subframe based on information from the PHY layer of the UE 102. The MAC layer may not instruct the PHY layer of the UE 102 to generate a transmission according to the stored UL grant, but may increment (by 1, for instance) a variable (e.g., CURRENT_IRV) that is an index into the sequence of redundancy versions. The MAC layer may also increment (by 1, for instance) a state variable (e.g., CURRENT_TX_NB) that indicates the number of transmissions if the subframe is determined as an uplink transmission subframe or even a non-PUSCH transmission subframe.

By this second implementation, if the UL-reference UL/DL configuration is the TDD UL/DL configuration of the serving cell, the HARQ process(es) and timing of the subframe bundling operation may be compatible with legacy UEs 102. Furthermore, this second implementation may be combined with the first implementation and first alternative implementation described above in connection with FIG. 8.

One example of subframe bundling with dynamic subframe type conversion according to the second implementation is illustrated in FIG. 8. In this example, a TDD UL/DL configuration (e.g., the first UL/DL configuration) is 6 and a UL-reference UL/DL configuration (e.g., the second UL/DL configuration) is 6. Because the DL-reference UL/DL configuration is 1, the fourth subframe is a flexible subframe (as indicated by an “X” in the subframe type). Because the DL-reference UL/DL configuration is 1, the fourth subframe may convert from a UL subframe to a DL subframe. In this example, the fourth subframe is included in a bundle of four consecutive UL subframes. However, if the fourth subframe is determined to be a DL subframe, the PUSCH transmission in the fourth subframe is dropped (as indicated in FIG. 11 by the cross in the corresponding bundling HARQ process).

It should be noted that although the first UL/DL configuration is 6 in this example, the consecutive UL subframes are determined based on UL-reference UL/DL configuration 6. Therefore, the PDCCH timing 1141 and PHICH timing 1143 for subframe bundling may be determined as described above in connection with FIGS. 6A and 6B.

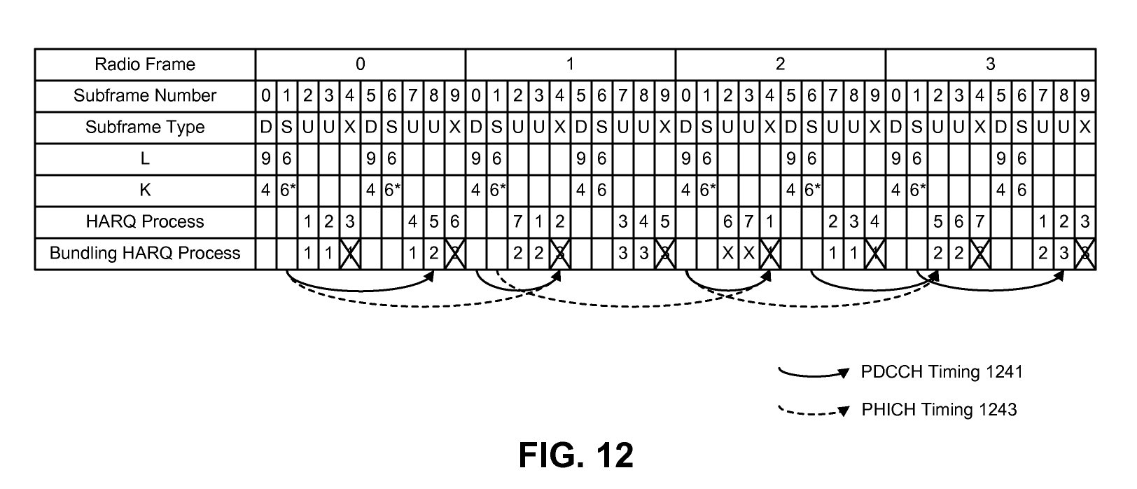

FIG. 12 illustrates another example of subframe bundling with dynamic subframe type conversion according to the second implementation. The PDCCH timing 1241 and PHICH timing 1243 are shown for four radio frames. The second implementation is described above in connection with FIG. 11. In this example, a TDD UL/DL configuration (e.g., the first UL/DL configuration) is 0 and a UL-reference UL/DL configuration (e.g., the second UL/DL configuration) is 0. Because the DL-reference UL/DL configuration is 1, the fourth subframe and the ninth subframe are flexible subframes (as indicated by an “X” in the subframe type). Therefore, the fourth subframe or the ninth subframe may convert from a UL subframe to a DL subframe. In this example, the fourth subframe and the ninth subframe are included in a bundle of four consecutive UL subframes. However, if the fourth subframe or the ninth subframe is determined to be a DL subframe, the PUSCH transmission in the subframe is dropped (as indicated in FIG. 12 by the cross in the corresponding bundling HARQ process).

It should be noted that although the first UL/DL configuration is 0 in this example, the consecutive UL subframes are determined based on UL-reference UL/DL configuration 0. Therefore, the PDCCH timing 1241 and PHICH timing 1243 for subframe bundling may be determined as described above in connection with FIGS. 7A and 7B.

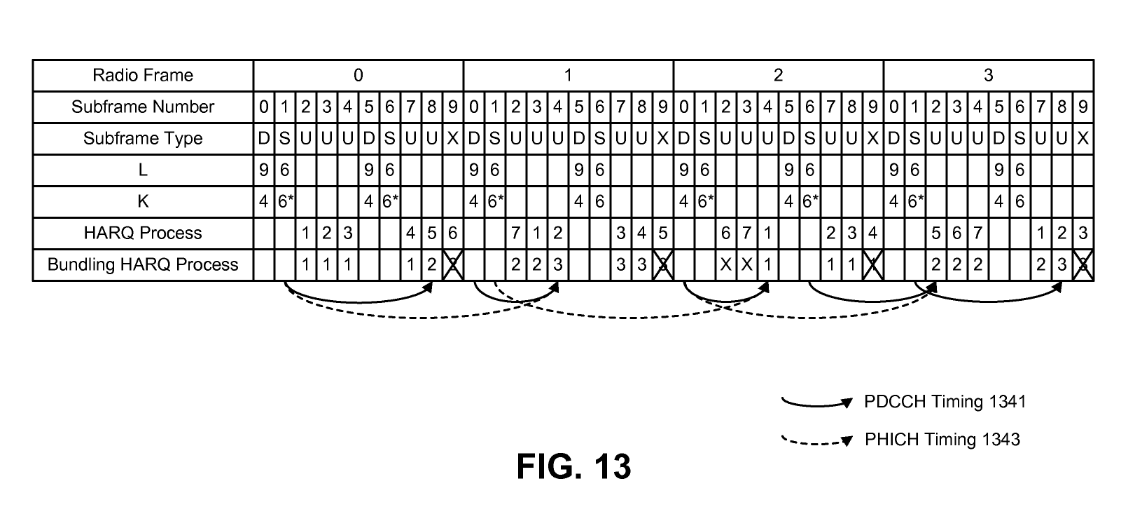

FIG. 13 illustrates yet another example of subframe bundling with dynamic subframe type conversion according to the second implementation. The PDCCH timing 1341 and PHICH timing 1343 are shown for four radio frames. The second implementation is described above in connection with FIG. 11. In this example, a TDD UL/DL configuration (e.g., the first UL/DL configuration) is 0 and a UL-reference UL/DL configuration (e.g., the second UL/DL configuration) is 0. Because the DL-reference UL/DL configuration is 6, the ninth subframe is a flexible subframe (as indicated by an “X” in the subframe type). Therefore, the ninth subframe may convert from a UL subframe to a DL subframe. In this example, the ninth subframe is included in a bundle of four consecutive UL subframes. However, if the ninth subframe is determined to be a DL subframe, the PUSCH transmission in the subframe is dropped (as indicated in FIG. 13 by the cross in the corresponding bundling HARQ process).

It should be noted that although the first UL/DL configuration is 0 in this example, the consecutive UL subframes are determined based on UL-reference UL/DL configuration 0. Therefore, the PDCCH timing 1341 and PHICH timing 1343 for subframe bundling may be determined as described above in connection with FIGS. 7A and 7B.

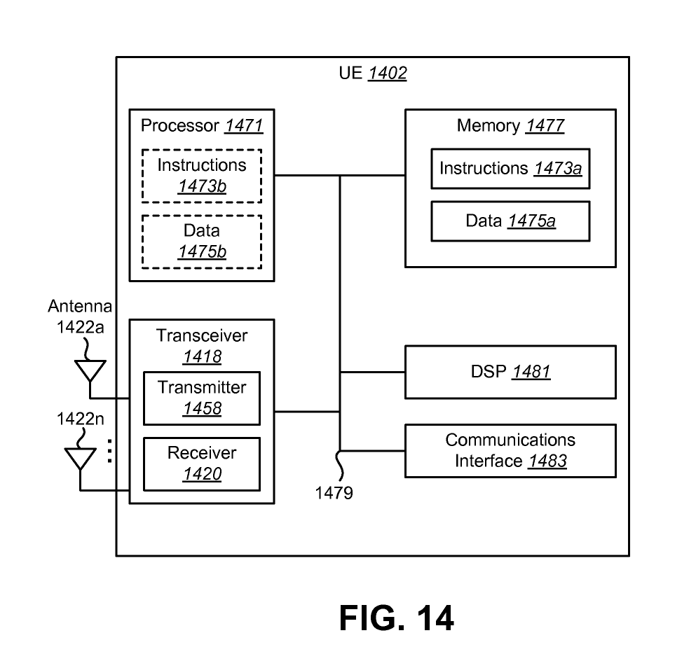

FIG. 14 illustrates various components that may be utilized in a UE 1402. The UE 1402 described in connection with FIG. 14 may be implemented in accordance with the UE 102 described in connection with FIG. 1. The UE 1402 includes a processor 1471 that controls operation of the UE 1402. The processor 1471 may also be referred to as a central processing unit (CPU). Memory 1477, which may include read-only memory (ROM), random access memory (RAM), a combination of the two or any type of device that may store information, provides instructions 1473a and data 1475a to the processor 1471. A portion of the memory 1477 may also include non-volatile random access memory (NVRAM). Instructions 1473b and data 1475b may also reside in the processor 1471. Instructions 1473b and/or data 1475b loaded into the processor 1471 may also include instructions 1473a and/or data 1475a from memory 1477 that were loaded for execution or processing by the processor 1471. The instructions 1473b may be executed by the processor 1471 to implement one or more of the methods 200 described above.

The UE 1402 may also include a housing that contains one or more transmitters 1458 and one or more receivers 1420 to allow transmission and reception of data. The transmitter(s) 1458 and receiver(s) 1420 may be combined into one or more transceivers 1418. One or more antennas 1422a-n are attached to the housing and electrically coupled to the transceiver 1418.

The various components of the UE 1402 are coupled together by a bus system 1479, which may include a power bus, a control signal bus and a status signal bus, in addition to a data bus. However, for the sake of clarity, the various buses are illustrated in FIG. 14 as the bus system 1479. The UE 1402 may also include a digital signal processor (DSP) 1481 for use in processing signals. The UE 1402 may also include a communications interface 1483 that provides user access to the functions of the UE 1402. The UE 1402 illustrated in FIG. 14 is a functional block diagram rather than a listing of specific components.

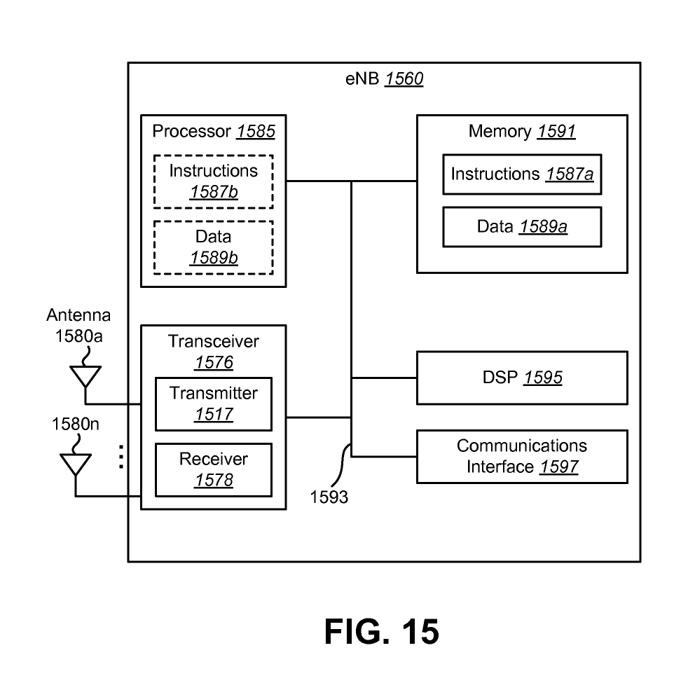

FIG. 15 illustrates various components that may be utilized in an eNB 1560. The eNB 1560 described in connection with FIG. 15 may be implemented in accordance with the eNB 160 described in connection with FIG. 1. The eNB 1560 includes a processor 1585 that controls operation of the eNB 1560. The processor 1585 may also be referred to as a central processing unit (CPU). Memory 1591, which may include read-only memory (ROM), random access memory (RAM), a combination of the two or any type of device that may store information, provides instructions 1587a and data 1589a to the processor 1585. A portion of the memory 1591 may also include non-volatile random access memory (NVRAM). Instructions 1587b and data 1589b may also reside in the processor 1585. Instructions 1587b and/or data 1589b loaded into the processor 1585 may also include instructions 1587a and/or data 1589a from memory 1591 that were loaded for execution or processing by the processor 1585. The instructions 1587b may be executed by the processor 1585 to implement one or more of the methods 300 described above.

The eNB 1560 may also include a housing that contains one or more transmitters 1517 and one or more receivers 1578 to allow transmission and reception of data. The transmitter(s) 1517 and receiver(s) 1578 may be combined into one or more transceivers 1576. One or more antennas 1580a-n are attached to the housing and electrically coupled to the transceiver 1576.

The various components of the eNB 1560 are coupled together by a bus system 1593, which may include a power bus, a control signal bus and a status signal bus, in addition to a data bus. However, for the sake of clarity, the various buses are illustrated in FIG. 15 as the bus system 1593. The eNB 1560 may also include a digital signal processor (DSP) 1595 for use in processing signals. The eNB 1560 may also include a communications interface 1597 that provides user access to the functions of the eNB 1560. The eNB 1560 illustrated in FIG. 15 is a functional block diagram rather than a listing of specific components.

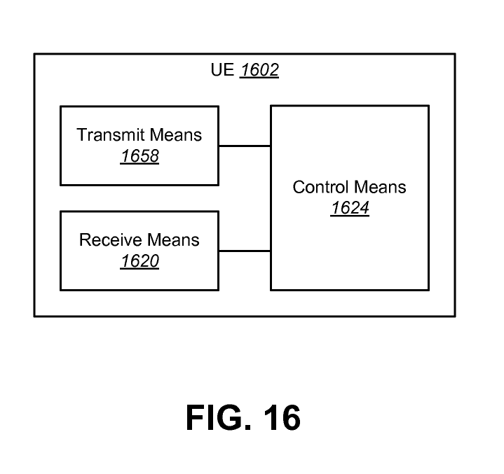

FIG. 16 is a block diagram illustrating one configuration of a UE 1602 in which systems and methods for subframe bundling may be implemented. The UE 1602 includes transmit means 1658, receive means 1620 and control means 1624. The transmit means 1658, receive means 1620 and control means 1624 may be configured to perform one or more of the functions described in connection with FIG. 2 and FIG. 14 above. FIG. 14 above illustrates one example of a concrete apparatus structure of FIG. 16. Other various structures may be implemented to realize one or more of the functions of FIG. 2 and FIG. 14. For example, a DSP may be realized by software.

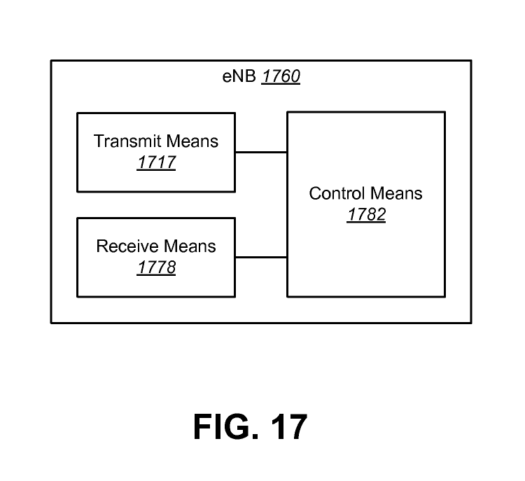

FIG. 17 is a block diagram illustrating one configuration of an eNB 1760 in which systems and methods for subframe bundling may be implemented. The eNB 1760 includes transmit means 1717, receive means 1778 and control means 1782. The transmit means 1717, receive means 1778 and control means 1782 may be configured to perform one or more of the functions described in connection with FIG. 3 and FIG. 15 above. FIG. 15 above illustrates one example of a concrete apparatus structure of FIG. 17. Other various structures may be implemented to realize one or more of the functions of FIG. 3 and FIG. 15. For example, a DSP may be realized by software.

The term “computer-readable medium” refers to any available medium that can be accessed by a computer or a processor. The term “computer-readable medium,” as used herein, may denote a computer- and/or processor-readable medium that is non-transitory and tangible. By way of example, and not limitation, a computer-readable or processor-readable medium may comprise RAM, ROM, Electrically Erasable Programmable Read-Only Memory (EEPROM), Compact Disc Read-Only Memory (CD-ROM) or other optical disk storage, magnetic disk storage or other magnetic storage devices, or any other medium that can be used to carry or store desired program code in the form of instructions or data structures and that can be accessed by a computer or processor. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

It should be noted that one or more of the methods described herein may be implemented in and/or performed using hardware. For example, one or more of the methods described herein may be implemented in and/or realized using a chipset, an application-specific integrated circuit (ASIC), a large-scale integrated circuit (LSI) or integrated circuit, etc.

Each of the methods disclosed herein comprises one or more steps or actions for achieving the described method. The method steps and/or actions may be interchanged with one another and/or combined into a single step without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A user equipment (UE) for performing subframe bundling, comprising:
a processor;
memory in electronic communication with the processor, wherein instructions stored in the memory are executable to:
determine consecutive uplink (UL) subframes based on UL subframes of a UL-reference uplink/downlink (UL/DL) configuration of a serving cell; and
perform a subframe bundling operation based on the consecutive UL subframes.

2. The UE of claim 1, wherein the consecutive UL subframes include a number of UL subframes corresponding to a transmission time interval (TTI) bundle size.

3. The UE of claim 1, wherein the instructions are further executable to drop a physical uplink shared channel (PUSCH) transmission in a subframe in a bundle if the subframe is determined to be a non-PUSCH transmission subframe.

4. The UE of claim 3, wherein determining whether the subframe is a non-PUSCH transmission subframe is based on physical (PHY) layer signaling.

5. The UE of claim 3, wherein determining whether the subframe is a non-PUSCH transmission subframe is based on a predetermined time division duplexing (TDD) UL/DL configuration.

6. The UE of claim 3, wherein determining whether the subframe is a non-PUSCH transmission subframe is based on a UL grant for the subframe.

7. The UE of claim 1, wherein a physical uplink shared channel (PUSCH) transmission in the flexible subframe does not occur.

8. The UE of claim 1, wherein the serving cell is configured to perform a dynamic subframe type conversion.

9. The UE of claim 1, wherein the instructions are further executable to determine the UL-reference UL/DL configuration based on a pair of a first UL/DL configuration and a second UL/DL configuration.

10. The UE of claim 1, wherein the instructions are further executable to determine the UL-reference UL/DL configuration based on radio resource control (RRC) dedicated signaling.

11. An evolved Node B (eNB) for performing subframe bundling, comprising:
a processor;
memory in electronic communication with the processor, wherein instructions stored in the memory are executable to:
determine consecutive uplink (UL) subframes based on UL subframes of a UL-reference uplink/downlink (UL/DL) configuration of a serving cell; and
perform a subframe bundling operation based on the consecutive UL subframes.

12. The eNB of claim 11, wherein the consecutive UL subframes include a number of UL subframes corresponding to a transmission time interval (TTI) bundle size.

13. The eNB of claim 11, wherein the instructions are further executable to assume that a physical uplink shared channel (PUSCH) transmission in a subframe in a bundle is dropped if the subframe is determined to be a non-PUSCH transmission subframe.

14. The eNB of claim 13, wherein determining whether the subframe is a non-PUSCH transmission subframe is based on physical (PHY) layer signaling.

15. The eNB of claim 13, wherein determining whether the subframe is a non-PUSCH transmission subframe is based on a predetermined time division duplexing (TDD) UL/DL configuration.

16. The eNB of claim 13, wherein determining whether the subframe is a non-PUSCH transmission subframe is based on a UL grant for the subframe.

17. The eNB of claim 11, wherein a physical uplink shared channel (PUSCH) transmission in the flexible subframe does not occur.

18. The eNB of claim 11, wherein the serving cell is configured to perform a dynamic subframe type conversion.

19. The eNB of claim 11, wherein the instructions are further executable to determine the UL-reference UL/DL configuration based on a pair of a first UL/DL configuration and a second UL/DL configuration.

20. The eNB of claim 11, wherein the instructions are further executable to determine the UL-reference UL/DL configuration based on radio resource control (RRC) dedicated signaling.

21. A method for performing subframe bundling by a user equipment (UE), comprising:
determining consecutive uplink (UL) subframes based on UL subframes of a UL-reference uplink/downlink (UL/DL) configuration of a serving cell; and
performing a subframe bundling operation based on the consecutive UL subframes.

22. The method of claim 21, further comprising dropping a physical uplink shared channel (PUSCH) transmission in a subframe in a bundle if the subframe is determined to be a non-PUSCH transmission subframe.

23. The method of claim 21, wherein a physical uplink shared channel (PUSCH) transmission in the flexible subframe does not occur.

24. The method of claim 21, further comprising determining the UL-reference UL/DL configuration based on a pair of a first UL/DL configuration and a second UL/DL configuration.

25. The method of claim 21, further comprising determining the UL-reference UL/DL configuration based on radio resource control (RRC) dedicated signaling.

26. A method for performing subframe bundling by an evolved Node B (eNB), comprising:
determining consecutive uplink (UL) subframes based on UL subframes of a UL-reference uplink/downlink (UL/DL) configuration of a serving cell; and
performing a subframe bundling operation based on the consecutive UL subframes.

27. The method of claim 26, further comprising assuming that a physical uplink shared channel (PUSCH) transmission in a subframe in a bundle is dropped if the subframe is determined to be a non-PUSCH transmission subframe.

28. The method of claim 26, wherein a physical uplink shared channel (PUSCH) transmission in the flexible subframe does not occur.

29. The method of claim 26, further comprising determining the UL-reference UL/DL configuration based on a pair of a first UL/DL configuration and a second UL/DL configuration.

30. The method of claim 26, further comprising determining the UL-reference UL/DL configuration based on radio resource control (RRC) dedicated signaling.
